(19) United States
(12) Patent Application Publication
(10) Pub. No.: US 2023/0191525 A1
(43) Pub. Date: Jun. 22, 2023

(54) ROBOTIC MESH STRUCTURE GENERATION FOR CONCRETE FORMWORK AND REINFORCEMENT

(71) Applicant: ETH Zurich, Zurich (CH)

(72) Inventors: Ammar Mirjan, Nussbaumen (CH); Mattis Koh, Zurich (CH); Fabio Matteo Gramazio, Zurich (CH); Matthias Kohler, Riedikon (CH); Marius Weber, Luzern (CH); Marvin Lee Rueppel, Zurich (CH)

(73) Assignee: ETH Zurich, Zurich (CH)

(21) Appl. No.: 17/997,526

(22) PCT Filed: Apr. 26, 2021
(86) PCT No.: PCT/EP2021/060837

§ 371 Date: Oct. 28, 2022

(30) Foreign Application Priority Data
Apr. 28, 2020 (EP) 20171861.6
Nov. 4, 2020 (EP) 20205631.3
Nov. 4, 2020 (EP) 20205632.1
Apr. 28, 2022 (EP) 20171865.7

(51) Int. Cl. B23K 11/00; B23K 9/00; B23K 9/007; B21F 15/08; B21F 27/10; B25J 9/16

(52) U.S. Cl. CPC B23K 11/0086; B23K 9/0035; B23K 9/007; B21F 15/08; B21F 27/10; B25J 9/1664; B23K 2101/22

(57) ABSTRACT

In one aspect the invention relates to a mobile robotic end-effector tool for generating a mesh structure for use in reinforced concrete building systems. The tool comprises: —at least one robotic end-effector (EE), being movable in six degrees of freedom for applying an endless secondary mesh structure (2 ms) to the provided primary mesh structure (1 ms) continuously by roll spot welding, —wherein the at least one robotic end-effector (EE) further comprises: —a welding unit (W), in particular a resistance welding unit, configured for welding the secondary mesh structure (2 ms) to the primary mesh structure (1 ms) at predefined connection positions to generate cross-wire connections; —contact force sensors, configured for measuring the contact force of the robotic end-effector (EE), being applied to the primary mesh structure (1 ms) during rolling over the primary mesh structure (1 ms); —a processor (P) for closed loop control of the at least one robotic end-effector (EE) by means of control signals, wherein the control signals are generated at least in part in response to the measured contact force.

The present invention is in the field of constructional engineering and in particular relates to a method for generating a mesh structure, which may be used for reinforcing concrete structures in building construction. Further, the invention refers to a robotic end-effector tool and a computer program.

In constructional engineering and/or automated manufacturing, mesh structures are used for a variety of different purposes and applications. In particular, metal meshes may be used as a reinforcement structure for being later filled with concrete for building walls and/or ceilings.

On the one hand, in today's constructional engineering systems, the requirements for further automation of the building process are increasing steadily for being able to save costs. On the other hand, building structures are getting more and more complex, and thus requiring three-dimensional mesh structures in complex shapes and forms with curvatures and a variety of concave and convex mesh structure sections.

In state-of-the-art it is known to use robotic systems for manufacturing reinforcement structures for building systems. For example, WO 2017/153559 A1 shows such an automated robotic set up for producing metal meshes. Although this system provides the option to manufacture meshes by means of a mobile digitally controlled robot, the system still has drawbacks with respect to performance and with respect to the field of application. The field of application is limited, because the secondary mesh structure (discrete metal wires or rebars), which is to be applied robotically on a primary mesh structure is restricted to discrete elements in a defined length This limits the system for structural applications since the reinforcement is only continuous in one direction.

An approach for automatically assembling planar rebar mats is shown in US 2018/0333764 A1. Two-dimensional rebar mats are placed on a support table for being processed by several articulated arm robots. However, with this system, it is not possible to manufacture more complex mesh structures with a plurality of different types of curvatures.

It is therefore an object of the present invention to provide a solution for generating mesh structures being usable in reinforced concrete construction, which generally requires appropriate and sufficient reinforcement structures for being able to provide load and/or force transfer. Moreover, the manufacturing process for these mesh structures should be further automated and performance shall be improved.

This object is solved by the appended independent claims, in particular by a partially computer implemented method for generating a mesh structure, a robotic end-effector tool and a computer program.

Further advantages, advantageous aspects, features and/or embodiments are mentioned in the dependent claims.

Further, it is to be pointed out that software typically is modular in nature. Thus, a specifically implemented feature which is mentioned in combination with a certain embodiment may also be combined with other features, even when mentioned in other embodiments. Accordingly, any feature may be combined with at least any other feature, which is claimed and/or described in this application, even when in another context.

In the following, the invention is described with respect to the claimed method. Features, advantages or alternative embodiments mentioned with respect to the method can also be assigned, transferred or, applied to the other claimed or described subject matters, like the apparatus type claims (e.g., directed on the tool or the computer program or a computer program product) and vice versa. In other words, the subject matter of the robotic end-effector tool can be improved or further developed with features described or claimed in the context of the method and vice versa. In this case, the functional features of the method are embodied by structural units of the system, configured to dedicatedly execute this function and vice versa, respectively. Generally, in computer science at least from a computational point of view, a software implementation and a corresponding hardware implementation are equivalent, at least from a computability perspective. Thus, for example, a method step for “storing” data may be performed with a “storage unit” and respective instructions to write data into the storage.

For avoiding redundancy, these embodiments are not reiterated or explicitly described again for the apparatus, because they have been described already in relation to the method.

Wherever not already described explicitly, individual embodiments, or their individual aspects and features, described herein can be combined or exchanged with one another, even when mentioned in other embodiments, without limiting or widening the scope of the described invention, whenever such a combination or exchange is meaningful and in the sense of this invention. Accordingly, any feature may be combined with at least one other feature, which is claimed and/or described in this application.

The order, according to which the steps of the method of the present invention are described in the present specification, does not necessarily reflect the chronological order, according to which said steps are carried out.

According to a first object, the present invention refers to a method for generating a mesh structure for use in architecture, engineering and/or construction, in particular for use in reinforcement systems, and more particular for use in reinforced concrete structures. The method consists at least of the following method steps:
Providing a primary mesh structure, which may comprise a variety of wires with different curvatures in different extensions and/or with different radii,
Using a robotic end-effector tool with at least one end-effector, wherein the (at least one) end-effector is movable (preferably on an articulated arm) in six degrees of freedom for applying a continuous or endless secondary mesh structure (e.g., a continuous metal wire strand) to the provided primary mesh structure—in particular continuously—by roll spot welding. In a preferred embodiment, the step of using the robotic end-effector tool may only be initiated, after having received an initiation signal (which, for example, may be provided on a user interface by a human operator) for providing an additional verification step.
and during rolling (the at least one end-effector) over the primary mesh structure for roll spot welding:
   instructing a welding unit, in particular a resistance welding unit, to initiate a welding process within a sequence of interrupted welding processes for welding the secondary mesh structure to the primary mesh structure at pre-defined connection positions to generate cross weldings;
   instructing a set of sensors to measure—preferably continuously—a contact force of the robotic end-effector, being applied to the primary mesh structure during rolling over the primary mesh structure;
   (in particular closed-loop) controlling the robotic end-effector in real-time by means of control signals, generated by a processor, wherein the control signals are generated at least in part in response to the measured contact force and in particular to reach a desired or targeted contact force (required to reach a sufficient welding connection).

The solution according to the present invention provides a number of advantages. By using the robotic end-effector tool, which is configured and engineered for roll spot welding and for welding the secondary mesh structure continuously, it is possible to use this method and system for reinforced concrete construction. In particular, mesh structures which are to be used for reinforcement of concrete have to comply with a set of requirements. One of these requirements is the transfer of the load and forces for the later building structure from a statical point of view. For example, if a curved wall needs to be manufactured with different radii, mesh portions with small radius of curvature (i.e., highly curved structure) need a different mesh density (in particular a higher density) than mesh portions with a big radius of curvature (i.e., less curved structure) and vice versa.

Further, for being able to provide a sufficient load transfer, the primary mesh structure should be reinforced with the secondary mesh structure in a continuous format. “Continuous format” means that the secondary mesh structure, for example a metal wire or a strand in another material, is welded to the primary mesh structure over preferably the whole length or over the whole width of the primary structure. In case the secondary mesh structure is to be applied horizontally, the secondary mesh structure preferably covers the whole width of the primary structure and extends from right to left (or vice versa). In this case (horizontal application of the second mesh structure), usually, the primary mesh structure comprises vertical elements or strands which serve as the basis for welding the secondary mesh structure. The secondary mesh structure is welded onto the primary mesh structure in a “continuous format”, meaning that the secondary mesh structure wire is welded at a plurality of cross-wire connections, and in particular at more than two cross-wire connections without cutting.

Another advantage is to be seen in the improved performance of the manufacturing method. In particular, the cycle time may be shortened by far as the end-effector needs no longer to engage with the primary building structure (e.g., to grip or clamp a strand of the primary mesh structure) for the purpose of connecting (welding) the secondary mesh structure to the primary mesh structure. By contrast, according to the invention, the end-effector continuously rolls over the primary mesh structure for roll spot welding. In particular in contrast to the robotic system, described in WO 2017/153559 A1, according to this invention, it is no longer necessary to stop the end-effector at a dedicated cross-wire position and to clamp the end-effector in this position in order to initiate the welding process. Further, it is not necessary to cut the metal strand (secondary mesh structure), which has been welded to the primary mesh structure after welding.

Moreover, performance may be improved by using more than one end-effector in the robotic end-effector tool. In particular, two robotic end-effectors may be used simultaneously or in parallel, for example at opposite sides of the primary mesh structure. Preferably, the two end-effectors are then controlled such as their vertical and width position (with respect to the primary building structure) is identical for optimally balancing the applied forces. Each of the at least one end-effector may be provided at an articulated robotic arm. The robotic arm is supported on a platform. The platform may be mobile. In particular, the platform may be configured for linear movement. Preferably, the platform may be moved by a drive motor, in particular of linear actuator. Preferably, the platform may be moved in the direction, being parallel with a plane of the primary mesh structure. In case, e.g., two end-effectors are used, two different articulated arms serve as support structure, which are themselves supports on two different platforms.

The contact force or pressure of the robotic end-effector, with which the robotic end-effector is “pressed” or forced against the primary mesh structure (and which therefore is applied to the primary mesh structure) is measured. Preferably, the contact pressure is measured continuously. The contact pressure is measured and may be processed (in particular locally) for providing contact force signals. The measured contact force represents a contact force to be applied during rolling over the primary mesh structure of the robotic end-effector. The contact force signals may be used for control of the robotic end-effector. This serves the technical purpose, that a uniform contact force shall be applied all over the primary mesh structure. For example, in case it is detected that the primary mesh structure bounces or springs back another force needs to be applied for assuring proper welding.

Preferably, the contact force is measured continuously. The contact force may be measured in such phases, where the end-effector rolls over the primary mesh structure for roll spot welding, whereas in phases, where the end-effector is repositioned for welding the next strand (secondary mesh structure) and/or is configured to change to another secondary mesh structure item (for example to a secondary mesh structure item with another diameter or to a secondary mesh structure item with another material) the detection of the contact force may be interrupted. In still another embodiment, the contact force is measured continuously and permanently, but not all of the measured contact force signals are going to be processed by a processing entity, for example the processor. In particular, in phases where the end-effector does not touch the primary mesh structure, it is not necessary to process the contact force signals.

The primary mesh structure (also abbreviated herein as primary structure) may be and preferably is a set or series of two-dimensional wire structures, that are not connected to each other yet. The primary mesh structure with the series of two-dimensional wire structures will be connected to each other by means of applying the secondary mesh structure as suggested by the invention. The primary mesh structure may alternatively be a 1D- or 3D mesh structure. The primary mesh structure may comprise a variety of wires with different curvatures in different extensions and/or with different radii. The primary mesh structure may be generated by means of using a robot, based on a digital 3D model. The 3D mesh structure may comprise concave and/or convex sections. The primary mesh structure may be of a reinforcement material. The primary mesh structure may preferably be steel. Alternatively, or in addition, bamboo, wood, carbon fiber, glass fiber or plastic material may be used as primary mesh structure.

The secondary mesh structure (also abbreviated herein as secondary structure) may be and preferably is a continuous wire or wire strand. The secondary mesh structure may be steel wire. The secondary mesh structure is preferably used to connect the series of primary mesh structure to generate the mesh structure. The term “mesh structure” is to be construed as that particular structure which needs to be manufactured (from or with the primary and the secondary mesh structure). The secondary mesh structure may be connected to the primary structure in various angles with respect to elements (wires) of the primary structure. Preferably, a 90° connection is selected. However, angles in between 0 and 90° may be set and used. Alternatively, or in addition, bamboo, wood, carbon fiber, glass fiber or plastic material may be used as secondary mesh structure. The secondary mesh structure may comprise a set of different items. For example, a first secondary mesh structure item may be a steel wire in 6 mm, a second item may be a wire in 8 mm, a third item may be wire in 12 mm etc. Typically, the secondary mesh structure is an endless or continuous structure in the form of a strand. The secondary mesh structure preferably is provided on coils. In a first embodiment, the coils for the different items of the secondary mesh structure are directly mounted on a platform of the robotic end-effector and thus locally. In a second embodiment, the coils for the different items of the secondary mesh structure are stored or shelved separately from the platform with the respective end-effector.

The secondary structure is preferably applied continuously, i.e., the secondary structure is connected as a continuous structure. The secondary mesh structure is not discrete and does not have a limited length. By contrast, the material, being provided to the end-effector is continuous. The secondary mesh structure may be cut to length after being welded onto the primary mesh structure. The fact that the secondary mesh structure is applied continuously in arbitrary directions is crucial for load transfer. This is therefore, an important feature of the present invention.

In a preferred embodiment, the secondary mesh structure is not cut to length while rolling over the primary mesh structure. In another preferred embodiment, the secondary mesh structure is not cut to length before an outer side of the primary mesh structure has been reached after the process of rolling over the primary mesh structure has started. This means, that typically, the process of rolling over starts at a first outer side (right/left side or bottom/upper side of the primary mesh structure) and proceeds to the opposite side thereof (in the examples above, correspondingly: left/right or upper/bottom side). The application of continuous secondary mesh material in continued with the same strand of material of secondary mesh structure until the respective opposite side of the primary mesh structure has been reached. The secondary mesh structure may—but is not required to (as it could also be bent in the other direction) —only be cut to length after one rolling over process ends and the opposite side has been reached.

The rolling over process is typically repeated at a different position, e.g., when rolling over is performed in horizontal direction, then a first rolling over process e.g., from left to right, may be performed in height A, and a second rolling over process may be performed, e.g., in height A+i, wherein i being an increment. The increment may be set by requirements of the 3D model. Accordingly, if rolling over is performed in vertical direction, the rolling over may be repeated for a subsequent next Y position, i.e., incremented position to the right or to the left. Also, in case the rolling over is to be performed in another angle, the end-effector will usually proceed until the opposite outer side of the primary mesh structure has been reached, if it is not instructed otherwise by the processor.

In a preferred embodiment, the rolling over process is executed while bending the secondary mesh structure in accordance with the outer form of the primary mesh structure in parallel. Preferably, the bending is executed by means of an anode of the welding unit. The anode may be configured as roller or rolling element, wherein the rotation axis of the anode is parallel to a surface of the primary mesh structure at that point and/or orthogonal to the movement direction of the rolling over movement (of the end effector).

It is possible to use more than one secondary mesh structure to be applied and connected to the primary mesh structure in parallel. In a preferred embodiment, different items of secondary mesh structure may be provided, for instance secondary mesh material items in different dimensions and/or materials. For example, the first item may be provided from a first coil and a second item of the secondary mesh structure may be provided from a second coil. The different items of secondary mesh structure are preferably processed by different end-effectors. So, for example the first end-effector is configured for bending and welding the first item of secondary mesh structure and the second end-effector is configured for bending and welding the second item of secondary mesh structure.

The generated mesh structure is a two- or three-dimensional mesh structure. The generated mesh structure may be or may comprise a metal structure. The generated mesh structure may be used for reinforcement of concrete structures in construction engineering or in other reinforcement systems. The generated mesh structure may be but is not required to be filled with concrete later. The generated mesh structure may be used for example in exhibition stand construction, in facade engineering and/or in furniture construction or related fields.

The cross welding(s) preferably are cross-wire weldings. But for specific applications, the primary structure may also be another structure, not a wire structure, like e.g., a surface structure like a plate or may be made from other material, than metal wire, like e.g., bamboo, as mentioned above.

The term “roll spot welding” relates to welding the secondary structure to the primary structure. Roll spot welding is done without interfering with the primary structure. It is not necessary to grip or clamp the primary structure of parts thereof for the welding process. The only prerequisite for the welding process is that the cathode of the welding unit of the end-effector needs to be in contact with the primary structure and in particular with an element of the primary structure during the welding process.

As described above, roll spot welding may imply that the secondary mesh structure is to be bent when being welded to the primary mesh structure in order to align the secondary mesh structure to the primary mesh structure. With other words, if the primary mesh structure for example shows a first concave section, followed by a second convex section, the secondary mesh structure needs to be adapted to and aligned with this curvature. Accordingly, also the secondary mesh structure will be bent so to provide a first concave section and a second convex section. With the bending process, it is assured that the secondary mesh structure “follows” the primary mesh structure.

The process of “rolling over” the primary mesh structure relates to the movement of the end-effector over said structure. The trajectory might be defined by a 3D model. The rolling over might be executed in a variety of different directions. Preferably, two main directions may be defined. In a first scenario, in which the primary mesh structure has (mainly) vertically extending elements, the secondary mesh structure is to be applied horizontally and might be ‘rolled over’ from left to right or vice versa. In this first scenario, the process of rolling over starts on the one side of the structure (e.g., to the right) and continues to the left until it ends at the opposite side (at the left most side). The process may then be re-iterated in the next height with the next secondary mesh structure item. In a second scenario, in which the primary mesh structure has (mainly) horizontally extending elements, the secondary mesh structure is to be applied vertically and might be ‘rolled over’ from top to bottom or vice versa. In this second scenario, the process of rolling over starts on the one side of the structure (e.g., bottom) and proceeds to the upward end until it ends at the opposite side (at the top most side). Also, here, the process may then be re-iterated in Y direction with the next secondary mesh structure item. However, these two scenarios are not the only ones, being feasible. It is also possible that the primary and/or secondary mesh structure may be provided or applied in other angles.

The sequence of interrupted welding processes may be and preferably is executed in one direction from one end or side of the primary mesh structure to the opposite side. In this phase (rolling over) the secondary mesh structure is usually not cut to length and is processed in a continuous form. After having completed one row or column (according to the respective mesh structure) of secondary mesh structure welding, there exist two options:
1. The wire, i.e., the secondary mesh structure is bent with a 180° so that the same wire may be used for the next line or row in the mesh structure.
2. Otherwise, the wire, i.e., the secondary mesh structure is not bent, but is cut to length.

Subsequently, the next row or line may be started with a new item of secondary mesh structure.

The control signals serve for—in particular closed loop—control of the end-effector.

According to a preferred embodiment of the present invention, the control signals comprise first control signals and second control signals. The control signals may also comprise at least two sections:
1. first control signals for controlling the movement of the end-effector as represented by a trajectory (when rolling over the primary mesh structure) and
2. second control signals, indicating welding parameters for executing the welding process and for controlling the welding process and in particular a time interval for the welding process. In particular, the starting time point, the end time point and/or duration of the welding process in the roll spot welding may be configured and/or controlled. Alternatively, or in addition, further parameters for the welding process, comprising voltage, current, duration etc. may be controlled.

In another preferred embodiment, the first control signals are determined in response to the measured contact force. The first control signals are determined such that the target contact force equals the measured contact force. In particular, the first control signals are or comprise instructions for instructing a set of actuators for positioning the end-effectors with the welding unit to adapt and/or control the contact force in order to reach the target contact force. Thus, first control signals are used to control a selection of the second control signals, in particular: the contact force. The instructed contact force is dependent on the stiffness or rigidity of the primary mesh structure. Generally, the less rigid and more compliant a primary mesh structure is, the more the robot (end effector) has to deviate from the (preset) trajectory to achieve the target welding force.

The control signals may be classified in static control signals, being constant during the course of rolling over, and dynamic control signals. The static control signals may be determined from a 3D model. The dynamic control signals are variable and may change during the course of rolling over. In particular, the dynamic control signals are continuously adapted in reply to the measured contact force. The dynamic control signals comprise the instructed contact force.

In a preferred embodiment the contact force is closed loop controlled dynamically. Thus, the contact force, being applied in a first welding process within the sequence of welding processes may differ from the contact force, being applied in a second welding process, dependent on the position in space, the engagement of other robotic end-effectors, being used in parallel and/or other criteria.

In a preferred embodiment, the first control signals for controlling the welding for generating the mesh structure are issued by a processing unit or a processor and are generated on the basis of a three-dimensional model and/or on the basis of the measured contact force. The trajectory for the end-effector for applying the second mesh structure to the primary mesh structure is calculated on the basis of the measured contact force in comparison the target contact force, which is required to be applied according to a three-dimensional model.

The second control signals may be provided from the same of from a different processor. The second control signals may be determined by means of the three-dimensional model and/or may be static. Alternatively, or in addition, the second control signals are calculated by taking into account measured (and may be dynamic) parameters of the end-effector. The measured parameters may comprise the contact force. The contact force represents the force which is applied for pressing the end-effector onto the primary mesh structure in the direction being perpendicular to the respective surface plane of the primary mesh structure.

Generally, in a preferred embodiment, the welding is closed loop controlled in an adaptive way. The control signals are part of a control loop for controlling/regulating disturbance variables/influences such as in particular the varying contact pressure/force. Alternatively, or in addition, also other disturbance variables like wire thickness changes (due to manufacturing tolerances) may be controlled. As a result, these processes deliver a reliably high weld quality,

For example, signals of optical sensor(s) at the head of the end-effector may be processed by the processor to analyze the electrode degradation of the welding unit. Also, wear of the electrodes may be analyzed—preferably for initiating counter measures.

The control signals and in particular the first control signals may be generated in response to the measured contact force and/or position signals. Further, the control signals may be generated in response to optical signals, detected form optical sensors, to thermal signals, detected by thermal sensors, and/or to inductive signals, detected by inductive sensors. The control signals may be determined by the processor in response to received signals, at least in response to position and/or contact force signals. The control of the contact force is relevant for in this invention, since first no clamps are used for fixing an end-effector or a part thereof to the workpiece to be processed (here: primary mesh structure). Second the work piece is not fixed statically, meaning that the primary mesh structure is resilient or compliant and may move if a force is applied in direction of the normal of the primary mesh structure onto the same.

Preferably, there is an active measuring of the contact force and the respective and corresponding real-time adaptive positioning of the end-effector with the welding unit (by means of controlling actuators (drive motors) for placement of the end-effector). Preferably, the contact force is measured for every or for selected points on the trajectory, the end-effector is required to travel (and/or the contact force is measured continuously or at selected time points). The “selected” time points may be preset and may be determined to equal the wire crossing locations (crossing of primary mesh structure and secondary mesh structure).

The integration of additional sensors in the end-effector may be used to improve the robustness and complement the system:
An optical sensor and/or inductive sensor can be used to measure, when a welding command can be executed. This may then serve as an alternative to receiving the initiation signal for the welding command from the 3D mode.
A thermal sensor can be used to improve the durability of the resistance welding parts that are exposed to wear and tear (e.g., anode and cathode). The sensor can measure the temperature of the parts and regulate cooling.

The processor serves inter alia for dynamically generating the control signals, in particular the first control signals, for robotic control. The processor may be implemented on the robotic end-effector tool directly or may be implemented on a separate computing instance, being in data exchange with the robotic end-effector tool. In particular, the processor may be distributed over a plurality of computing entities and may for example be implemented directly on the end-effectors of the end-effector tool, directly. In another embodiment, a (e.g., central) server may be provided, being in data exchange with the end-effector tool and/or its components.

The processor may be a central processing unit and may comprise hardware and software components, the latter also in the form as embedded software and/or algorithms. The CPU may comprise or may be provided as a microprocessor, a field programmable gate array (an acronym is “FPGA”) or an application specific integrated circuit (an acronym is “ASIC”). The CPU may serve to execute different internal functions of computing entities in the context of robotic mesh generation. The processor, inter alia, may serve to generate the control signals, in particular the dynamic control signals, which may vary over time during rolling over and/or to instruct components of the end-effector.

Alternatively, or in addition to this, the processor may further be designed to generate a set of alarm messages in case the sensor signals have been evaluated and indicate problematic state of the end-effector and to prepare the alarm messages to be displayed on a display unit, i.e., to calculate a graphical representation of the instant state of the end-effector and/or generated mesh for being displayed on e.g., a monitor of a remote central server.

Alternatively, or in conjunction with the above, the method may further comprise the step of:
generating a virtual representation of the generated mesh structure, based on optical sensors.

The virtual representation of the generated mesh, being generated so far, may be stored and serves to provide an automatically generated documentation of the mesh generation procedure carried out by the end-effector(s). Alternatively, or in conjunction with the above, the signals of the optical sensors and/or the virtual representation may be used to automatically validate and, if needed, correct the procedure. Moreover, by using the optical sensor signals and/or the virtual representation, the processor may automatically compare the actual state of the mesh with the target state as per 3D model and in case of deviations, may initiate counter measures and/or to inform the operator. With this, it is possible to track, store and/or verify the mesh generation procedure with intermediate steps and thus also during the process of mesh generation.

The robotic end-effector tool may comprise one or more end-effector(s). In the latter case, e.g., two end-effectors may be used for applying two different items of the secondary mesh structure from opposite sides to the primary mesh structure so that tilting moments (due to the applied force, mainly extending in a horizontal extension) for the primary mesh structure may be eliminated as much as possible. Therefore, the two end-effectors may be positioned “in common” with respect to the primary mesh structure. In particular, their movement and trajectory may be controlled such as their Y and Z position in space may be nearly the same, when assuming that the primary mesh structure mainly extends in a plane in Y- and Z-dimension (although the primary mesh structure may comprise curvatures and the secondary mesh structures are configured to “follow” this curvature).

In a preferred embodiment, the end-effector may be mobile itself, but is not required to be mobile itself, since it may be attached to a mobile platform. A robot serving as end-effector or end-effector tool may e.g., be fixed or mounted on a ground or on a linear track and/or may be combined with a mobile unit for providing mobility.

According to a preferred embodiment, the welding unit is a resistance welding unit. Resistance welding is favored since it is an economical way to join two pieces of metal wire. Resistance welding allows for a high speed, repeatability/reproducibility and robotic integration. Alternatively, the welding unit may be configured as a gas metal arc welding unit or a tying gun for providing a tying connection. The welding unit is preferably configured for roll spot welding. Further, preferably, the welding unit is configured for joining two metal wires or strands or other mesh components. The weld is made by conducting a strong current through the metal combination to heat up and finally melt the metals at localized point(s). The welding process is defined by a set of parameters, comprising welding current, welding time, welding or contact force, and/or material properties, like diameter, type of material, surface coatings and/or others.

The contact force influences the resistance welding process by its effect on the contact resistance at the interfaces and on the contact area (or point) due to deformation of the primary and secondary mesh materials. The elements of the primary and secondary mesh structures must be compressed with a certain force at the weld spot to enable the passage of the current. If the welding force is too low, expulsion may occur immediately after starting the welding current due to fact that the contact resistance is too high, resulting in rapid heat generation. If the welding force is high, the contact area will be large resulting in low current density and low contact resistance that will reduce heat generation and the size of weld nugget. In consequence, it is to be assured that the correct contact force is to be applied for providing high quality welding results and thus high-quality reinforcement structures.

According to another preferred embodiment, the secondary mesh structure is bent by means of the end-effector during rolling over the primary mesh structure, in particular according to a curvature of the first mesh structure.

According to still another preferred embodiment, rolling over the primary mesh structure is not interrupted by a cutting process. Further, the step of ‘rolling over’ does not comprise cutting the secondary mesh structure to length before the end of the primary mesh structure is reached. For example, if the secondary mesh structure is to be welded in a horizontal direction to the primary mesh structure, the primary mesh structure will not be cut before the right or left and of the primary mesh structure is reached. Depending on the digital data of the three-dimensional model, it is not necessary to cut the secondary mesh structure after having completed “one row” within a sequence of interrupted welding processes. It is possible to bend the secondary mesh structure in the opposite direction to continue with rolling over (the primary mesh structure) with the same secondary mesh structure to be applied in the opposite direction (Y direction), and thus starting the next row.

Preferably, the sequence of interrupted welding processes is applied with one and the same endless secondary mesh structure. This means, that the secondary mesh structure is welded in a continuous format which significantly improves statical requirements (transfer of forces). Thus, during the sequence of interrupted welding processes, the secondary mesh structure remains in endless form and is not cut.

In another preferred embodiment, a welding process is instructed automatically in response to a digital control signal, wherein the digital control signal is generated by processing a 3D mesh model. In another embodiment, the welding process or selected welding processes are only initiated in response to an initiation signal. The initiation signal may be provided, for example, on a user interface by a human operator.

In a first preferred embodiment, only one end-effector is used and the end-effector tool comprises only one end-effector.

In second preferred embodiment, and as mentioned above, the robotic end-effector tool comprises at least two separate end-effectors at two different robotic arms, wherein the at least two separate end-effectors are used in parallel for applying different items of the secondary mesh structure to the primary mesh structure, in particular on the same height and/or in the same longitudinal extension from opposite sides.

In a first embodiment, the two or more end-effectors are working with different secondary mesh structure item (for example, secondary mesh structures with different diameter and/or different material). In a second embodiment, the two or more end-effectors are working on opposite sides of the primary mesh structures on the same height level and/or at nearly the same width position (Y axis). Technical advantage is a balance of applied forces to the primary mesh structure.

According to another preferred embodiment, the contact force is measured by means of a force measurement sensor, which is attached at a head of the robotic end-effector, in particular in an area where the contact force is applied.

Generally, the force measurement sensor (also mentioned shortly herein as ‘force sensor’) may be implemented as load cell. The force measurement sensor can be mounted in various positions at the head of the end-effector. It is important to calibrate it appropriately so that, for example, the dead weight of the end-effector can be compensated. Preferably, the force sensor is mounted between the robot's arm (wrist of the robot) and the end-effector. In this position, all forces on the robot are diverted or guided to the robot. The orientation of the force measurement sensor then also corresponds or is aligned to the coordinate system of the robot thereby easing the calibration process. Moreover, the force measurement sensor is also protected from the high currents of contact welding. In particular, the contact force is measured between the secondary wire pressing onto the primary structure and the rolling electrode (anode). The force direction is from the center of the rolling electrode, normal to curve that represents the desired trajectory of the secondary wire being applied.

According to a preferred embodiment, the secondary mesh structure is welded to the primary mesh structure horizontally or vertically or in an angle between 0° and 90° with respect to a direction of an element of the primary mesh structure. This makes it possible that the mesh structure is generated according to variable conditions so that a high degree of flexibility may be reached.

In still another preferred embodiment, the at least one end-effector is adapted:
to weld the secondary mesh structure onto the primary mesh structure;
to weld-off elements (wire) of the primary mesh structure;
to move and in particular to roll over the primary mesh structure, by translatory and/or rotational movements, depending on the curvature of the primary mesh structure;
to bend the secondary mesh structure, according to the curvature of the primary mesh structure, in particular in case the primary mesh structure is not planar, and/or at the end of the structure; and/or
to cut the secondary mesh structure after completion of the sequence of interrupted welding processes.

According to another preferred embodiment, the at least one end-effector comprises an anode and a cathode, wherein the anode is provided as rotating roller and the cathode is provided as rotating dog or carrier, which hops or skips to a next element of the primary mesh structure.

According to a preferred embodiment, the anode serves as part of the welding unit (the welding unit comprises anode and cathode) and in addition as bending unit. This has the advantage that the end-effector may be constructed with less parts and may be cheaper to manufacture. The bending unit is a metallic component, preferably copper, which is mounted rotatably so to rotate around a rotational axis which extends parallel to the surface plane of the primary mesh structure and/or perpendicular to the movement direction of the end-effector (rolling over direction).

The carrier may be spring-mounted. The carrier may be provided in a rectangular or in another lengthy form. The respective next element is e.g., a vertical element of the primary mesh structure over which the end-effector rolls in a horizontal direction. The carrier then hops from one vertical element of the primary mesh structure to the next. In another embodiment, the secondary mesh structure is to be applied in a vertical direction and main elements of the primary mesh structure are in the horizontal direction. Thus, the secondary mesh structure may be applied in an upwards or downwards direction to the primary mesh structure. Here, the carrier hops from one horizontal element of the primary mesh structure (or row) to the next. Also, an oblique rolling over direction may be instructed. In this case, it would potentially need some light adaptation, such as e.g., the carrier could also be configured a roll like the anode or it could have some spring-rotating mechanism that enables it to adjust to different angles.

The end-effector may preferably comprise a rebar threader, which in configured for providing the secondary mesh structure (in the form of rebar wire) to the end-effector for the purpose of bending and welding. The rebar threader is a metallic component for providing the secondary mesh structure through a hollow structure, in particular an aperture. The rebar threader supports the wire, holding it at the correct height, mainly parallel to the primary mesh structure. Additionally, it acts as a bending point (bending pin) while bending the secondary wire. Additionally, it enables to make sure that there is no collision between the wire feed of the secondary wire (secondary mesh structure) to the primary mesh structure, since the robot can rotate the rebar threader away from the structure.

In a preferred embodiment, the at least one robotic end-effector is placed on a mobile platform. The platform is not legged or wheeled. The mobile platform is preferably configured for lateral movement, preferably in one axis (Y axis). Thus, the platform is transferable by a linear actuator for linear movement, in particular parallel to a plane of the primary mesh structure. In more complex scenarios, the mobile platform may be movable also in other directions, for example in X-, Y- and/or even Z-axis. In another preferred embodiment, the at least one robotic end-effector may remain static and is not placed on a mobile platform and the primary mesh structure is moved with respect to the robot. Thus, the rolling-over movement may be accomplished by relative movement between the primary mesh structure and the end-effector.

According to a preferred embodiment, the robotic end-effector is moved along a desired trajectory over the primary mesh structure according to control instructions which are calculated on the basis of a digital 3D-model and adapted based on the contact force measured. Preferably, the trajectory is preset and defined by the three-dimensional model. However, the controller instructions for controlling the welding processes, and in particular the position of the end-effector with the welding unit for initiating or executing the welding, are not preset and are calculated dynamically in response to measured signals at the head of the end-effector in order to achieve a desired contact force. The other welding settings (like: current, welding time, welding start signal) are preferably preset from the 3D model.

In another aspect the present invention refers to a robotic end-effector tool for generating a mesh structure for use in constructional engineering, like architecture, engineering and/or construction, in particular for use in reinforcement systems, which is configured to be used in a method according to any of the preceding method claims, comprising:
at least one end-effector, being movable in six degrees of freedom for applying an endless secondary mesh structure to the provided primary mesh structure continuously by roll spot welding,
   wherein the at least one end-effector further comprises:
   a welding unit, configured for welding the secondary mesh structure to the primary mesh structure at pre-defined connection positions to generate cross-wire connections by means of a welding unit, in particular a resistance welding unit; preferably, the welding unit comprises an anode and a cathode.
   contact force sensors, configured for measuring the contact force of the robotic end-effector, being applied to the primary mesh structure during rolling over the primary mesh structure;
a processor for closed loop control of the at least one robotic end-effector by means of control signals, wherein the control signals are generated at least in part in response to the measured contact force.

In a preferred embodiment, the welding unit and in particular the anode thereof serves a bending unit or is configured for bending the secondary mesh structure while rolling over the primary mesh structure. The anode may be configured as roller with a rotation axis being parallel to the plane of the primary mesh structure. The rotation axis may be orthogonal to the movement direction of the end-effector.

In another aspect, the invention relates to a computer program comprising a computer program code, the computer program code when executed by a processor causing a robotic end-effector tool according to the directly preceding claim to perform the steps of the method of any of the preceding method claims, when the robotic end-effector is provided with a primary mesh structure and in case an initiation signal is provided. The instructing steps and the controlling are preferably computer-implemented. Thus, the method is computer-implemented, provided, that the primary mesh structure is provided to the end-effector.

The properties, features and advantages of this invention described above, as well as the manner they are achieved, become clearer and more understandable in the light of the following description and embodiments, which will be described in more detail in the context of the drawings.

In another first aspect or embodiment (application number EP 20 171 861.6), the invention relates to a primary building structure fabrication system, comprising:
a processing unit; and
at least one manipulator, in particular the robotic end-effector;

wherein, the processing unit is configured to receive fabrication information; wherein, one or more manipulators are configured to fabricate a plurality of sections of a primary building structure (also called a primary mesh structure); wherein, each section comprises at least one strand (in particular wire strand); wherein, the at least one strand comprises one or more of wire, rod or band; and wherein, the fabrication of the plurality of sections comprises utilization of the fabrication information.

In this first embodiment, the manipulator of the at least one manipulator may be configured to align one or more sections of the plurality of sections on a platform, and wherein the alignment comprises utilization of the fabrication information.

In this first embodiment, the manipulator may be configured to position a first section of the plurality of sections on the platform, and wherein the manipulator is configured to align the one or more sections relative to the first section.

In this first embodiment, the manipulator of the at least one manipulator may be configured to fix the plurality of sections to the platform.

In this first embodiment, the manipulator may be configured to fix the plurality of sections to the platform such that they can subsequently be released from the platform.

In this first embodiment, fixation of the plurality of sections to the platform by the manipulator may comprise one or more of: gluing; clamping; tying; utilizing magnets; MIG/MAG welding; or contact welding.

In this first embodiment, the at least one strand of a section comprises a first strand and comprises a second strand, and wherein to fabricate the section the one or more manipulators may be configured to fix one or more interconnecting strands the first strand and to the second strand.

In this first embodiment, to fabricate a section the one or more manipulators may be configured to bend the at least one strand of the section.

In this first embodiment, the at least one strand of a section may comprise a first strand and comprises a second strand, and wherein to fabricate the section the one or more manipulators may be configured to bend the first strand and/or the one or more manipulators are configured to bend the second strand.

In this first embodiment, the at least one strand of a section comprises a first strand and comprises a second strand, wherein to fabricate the section the one or more manipulators are configured to fix a first interconnecting strand to the first strand and fix the first interconnecting strand to the second strand; wherein the one or more manipulators are configured to bend the first strand and/or bend the second strand; and wherein the one or more manipulators may be configured to fix a second interconnecting strand to the first strand and fix the second interconnecting strand to the second strand, such that a section of the first strand between the first interconnecting strand and the second interconnecting strand and/or a section of the second strand between the first interconnecting strand and the second interconnecting strand is bent, wherein the bending and fixing comprises utilization of the fabrication information.

In this first embodiment, the system comprises a stabilization platform, and wherein to fabricate a section the one or more manipulators are configured to bend the at least one strand of the section whilst at least a part of the at least one strand is in contact with the stabilization platform such that the section conforms to a surface plane of the stabilization platform.

In this first embodiment, the at least one strand of a section comprises a first strand and comprises a second strand, wherein after the one or more manipulators have bent the first strand and/or bent the second strand, the one or more manipulators may be configured to align the first strand relative to the second strand, wherein the alignment comprises a movement and/or a further bending of the first strand and/or the alignment comprises a movement and/or a further bending of the second strand, and wherein the alignment may comprise utilization of the fabrication information.

In this first embodiment, the alignment may comprise an alignment of a plurality of segments of the first strand relative to a plurality of segments of the second strand, and wherein after a segment of the first strand is aligned relative to a segment of the second strand, the segment of the first strand is fixed to the segment of the second strand with an interconnecting strand.

In this first embodiment, the one or more manipulators are configured to fix the interconnecting strand to the segment of the first strand and to the segment of the second strand.

In this first embodiment, the at least one strand of a section may comprise a first strand and comprises a second strand, and wherein the one or more manipulators are configured to bend the first strand and/or bend the second strand whilst an end of the first strand is fixed relative to an end of the second strand.

In this first embodiment, the manipulator may be configured to fix a part of one strand to a part of another strand and/or fix one part of strand to another part of the same strand, wherein the fixation comprises: tying; MIG/MAG welding; or contact welding.

In this first embodiment, the one or more sections are fabricated and aligned on the platform such that at least one part of the at least one strand for each section of the one or more sections is located at or near a corresponding at least one of a plurality of intersection points defined within the fabrication information.

In this first embodiment, the at least one of the plurality of intersection points defined within the fabrication information is useable for the alignment and/or attachment of a feed strand to the primary building structure formed from the plurality of sections.

In second embodiment a wire section fabrication manipulator may be provided, wherein the manipulator is configured to be controlled to fabricate a section of a primary building structure out of at least one strand; wherein the at least one strand comprises one or more of wire, rod or band; and wherein the control comprises utilization of fabrication information.

In this second embodiment, the manipulator may be configured to bend the at least one strand of the section.

In this second embodiment, the manipulator may comprise a first strand interactor and a second strand interactor, wherein the first strand interactor is configured to support, hold or grasp a first strand of the at least one strand of the section and wherein the second strand interactor is configured to support, hold or grasp a second strand of the at least one strand of the section, and wherein the first strand interactor is configured to move relative to the second strand interactor on the basis of the fabrication information.

In this second embodiment, the first strand interactor may comprise a first part and a second part and the second strand interactor comprises a first part and a second part, wherein the first part of the first stand interactor is configured to contact a first side of the first strand and the second part of the first stand interactor is configured to contact a second side of the first strand opposite to the first side, and wherein the first part of the second stand interactor is configured to contact a first side of the second strand and the second part of the second stand interactor is configured to contact a second side of the second strand opposite to the first side.

In a third embodiment, a wire section alignment manipulator may be provided, wherein the manipulator is configured to be controlled to align one or more sections of a plurality of sections of a primary building structure on a platform; wherein each section comprises at least one strand; wherein the at least one strand comprises one or more of wire, rod or band; and wherein the control comprises utilization of fabrication information.

In this third embodiment, the manipulator may be configured to be controlled to position a first section of the plurality of sections on the platform, and wherein the manipulator is configured to align the one or more sections relative to the first section.

In this third embodiment, the manipulator may be configured to be controlled to fix the plurality of sections to the platform.

In a fourth embodiment, a method of fabricating a primary building structure is provided, the method comprising:

a) receiving by a processing unit fabrication information; and

b) fabricating with a manipulator of at least one manipulator a plurality of sections of a primary building structure; wherein, each section comprises at least one strand; wherein, the at least one strand comprises one or more of wire, rod or band; and wherein, the fabricating the plurality of sections comprises utilizing the fabrication information.

Another fifth aspect or embodiment (according to application number EP 20 171 865.7) of the invention relates to a building structure fabrication system for feed wire, feed rod or feed band, the system comprising:
a processing unit; and
a manipulator; wherein, the processing unit is configured to receive assembly information; wherein, the manipulator is configured to align a feed to a primary structure at a plurality of intersection points; wherein, the feed is a feed wire, feed rod, or feed band; wherein, the primary structure is a primary wire structure, primary rod structure, or primary band structure; and wherein, the alignment of the feed to the primary structure at the plurality of intersection points comprises utilization of the assembly information.

In this fifth embodiment, the manipulator may be configured to align the feed to the primary structure at a first intersection point of a pair of adjacent intersection points and then align the feed to the primary structure at a second intersection point of the pair of adjacent intersection points.

In this fifth embodiment, the manipulator may be configured to bend the feed, and wherein alignment of the feed to the primary structure at the plurality of intersection points comprises a bending of the feed between at least one pair of adjacent intersection points.

In this fifth embodiment, the manipulator may be configured to attach the feed to the primary structure at the plurality of intersection points.

In this fifth embodiment, attachment of the feed to the primary structure at the plurality of intersection points comprises utilization of the assembly information.

In this fifth embodiment, the manipulator is configured to attach the feed to the primary structure at a first intersection point of a pair of adjacent intersection points and then attach the feed to the primary structure at a second intersection point of the pair of adjacent intersection points.

In this fifth embodiment, attachment of the feed to the primary structure at the plurality of intersection points may comprise a bending of the feed between at least one pair of adjacent intersection points.

In this fifth embodiment, the manipulator may be configured to attach the feed to the primary structure at a first intersection point of a pair of adjacent intersection points and then bend the feed between the pair of adjacent intersection points and then attach the feed to the primary structure at a second intersection point of the pair of adjacent intersection points.

In this fifth embodiment, the manipulator may be configured to move at least one wire or rod or band segment of the primary structure, and wherein attachment of the feed to the primary structure at the plurality of intersection points comprises a movement of the at least one wire or rod or band segment of the primary structure.

In this fifth embodiment, the manipulator may be configured to move the at least one wire or rod or band segment of the primary structure such that a part of the at least one wire or rod or band segment is positioned at a corresponding at least one intersection point, such that the feed is attached to the at least one wire or rod or band segment at the at least one intersection point.

In this fifth embodiment and also in other embodiments mentioned herein, attachment of the feed to the primary wire structure at the plurality of intersection points comprises: tying; MIG/MAG welding; or contact welding.

In this fifth embodiment, the system comprises at least one sensor device which may be configured to determine manipulator information, wherein the manipulator information comprises one or more of: a location of the manipulator relative to at least one intersection point; a distance between the manipulator and at least one part of the primary structure; a distance between the manipulator and at least one intersection point; a determined contact between the manipulator and at least one part of the primary structure; a contact force between the manipulator and at least one part of the primary structure; a torque being applied to the manipulator, and wherein the alignment of the feed to the primary structure at the plurality of intersection points comprises utilization of the manipulator information.

In this fifth embodiment and also in other embodiments, mentioned herein, the system comprises at least one sensor device configured to determine manipulator information, wherein the manipulator information comprises one or more of: a location of the manipulator relative to at least one intersection point; a distance between the manipulator and at least one part of the primary structure; a distance between the manipulator and at least one intersection point; a determined contact between the manipulator and at least one part of the primary structure; a contact force between the manipulator and at least one part of the primary structure; a torque being applied to the manipulator; and wherein the attachment of the feed wire to the primary structure at the plurality of intersection points comprises utilization of the manipulator information.

In a sixth embodiment, a manipulator is provided for feed wire, feed rod or feed band, wherein the manipulator is configured to be controlled to align a feed wire, feed rod or feed band to a primary structure at a plurality of intersection points; wherein the primary structure is a primary wire structure, primary rod structure, or primary band structure; and wherein the alignment of the feed wire, feed rod or feed wire to the primary structure at the plurality of intersection points comprises utilization of assembly information.

In the sixth embodiment, the manipulator comprises a roller configured to engage with and roll along the feed wire or feed rod or feed band.

In the sixth embodiment, the manipulator comprises a conduit section (in particular a rebar threader) through which the feed wire or feed rod or feed band is configured to run.

In the sixth embodiment, the roller and conduit section are part of a head portion of the feed manipulator (also called end-effector).

In the sixth embodiment, the manipulator comprises a transformer.

In the sixth embodiment, the manipulator comprises a cathode system and/or an anode system.

In the sixth embodiment, the roller is part of the part of the anode system.

In the sixth embodiment, the manipulator comprises a cathode copper plate that is part of the cathode system and is arranged adjacent to the roller.

In the sixth embodiment, the manipulator comprises a clamp configured to clamp a wire or rod or band segment of the primary building structure to the feed wire or feed rod or feed band at or in the vicinity of an associated intersection point.

In the sixth embodiment, the clamp is part of the cathode system.

In a seventh embodiment, a method of fabricating a building structure is provided, the method comprising:
receiving by a processing unit assembly information; and
aligning with a manipulator a feed to a primary structure at a plurality of intersection points, comprising utilizing the assembly information; wherein, the feed is a feed wire, feed rod, or feed band; and wherein, the primary structure is a primary wire structure, primary rod structure, or primary band structure.

In an eight aspect or embodiment (according to application number EP 20 205 631.3), the invention relates to a method for generating a mesh structure, comprising the steps of:
providing a first mesh structure, the first mesh structure being a two- or three-dimensional mesh structure;
processing a mesh geometry of the first mesh structure based on an input parameter set to define an operational environment; and
generating a set of robot instructions to apply additional material to the first mesh structure based on the defined operational environment, the additional material being used for modifying the first mesh structure in order to provide a second mesh structure.

So, densification according to the suggestion presented herein, can also make sense in terms of the geometry of the structure regarding the filling. An overhanging structure might need a denser mesh on one side, to prevent loss of concrete during filling, whereas on the other side, it can have the minimal, structural relevant, reinforcement. Generally, the additional material may be used to modify the first mesh structure in order to provide a second mesh structure. Modifying, according to a first embodiment may comprise adding material and thus a densification of the first mesh structure. In a second embodiment, the step of modifying may comprise removing material form the first mesh structure to provide a lighter second mesh structure with less material. In this case, modifying may be performed by taking away material form the first mesh structure or by not adding additional material. The second mesh structure may be the first mesh structure with modifications, for example, with more material than the first mesh structure for densification reasons. For example, more feed wire may be added to the first mesh structure or more wire may be added to the strands. The feed wire and/or the wire for the strands may be of variable diameter, variable length, different material than the material of the first mesh structure, or the like. The additional material may be applied to the first mesh structure in a horizontal and/or vertical direction. By attaching additional material, it is, for example, possible to densify the first mesh structure according to specific requirements. For example, if a part of the first mesh structure needs to be densified, additional material is applied to this part of the first mesh structure while keeping the other parts of the first mesh structure unchanged. Thus, a second mesh structure is obtained which comprises a more densified part compared to the remaining parts.

In this eighth embodiment, the method may further comprise:
applying the additional material at a defined location of the first mesh structure based on the set of robot instructions using a robotic system in order to provide the second mesh structure.

In this eighth embodiment, applying the additional material may be performed iteratively in order to provide the second mesh structure.

In this eighth embodiment, providing the first mesh structure may comprise providing a pre-constructed mesh structure as the first mesh structure.

In this eighth embodiment, providing the first mesh structure may comprise constructing an initial mesh structure and providing the constructed initial mesh structure as the first mesh structure.

In this eighth embodiment, the input parameter set is directed to a characteristic of the second mesh structure to be provided.

In this eighth embodiment, the input parameter set indicates a structural analysis with regard to the second mesh structure, a force flow of the second mesh structure, an orientation of the second mesh structure, and/or a set of thresholds regarding an amount of material being used for the second mesh structure.

In this eighth embodiment, the operational environment defines an amount of the additional material to be added to the first mesh structure, a type of material to be used as the additional material, spatial information indicating a spatial position where to add the additional material to the first mesh structure to provide the second mesh structure, and/or type of connection.

In this eighth embodiment, the amount of the additional material to be added to the mesh structure, the type of material to be used as the additional material, and/or the type of connection are position dependent and in particular depend on a position where the additional material is to be added to the first mesh structure.

In this eighth embodiment, applying the additional material at the defined location of the first mesh structure comprises gravity-based application of the additional material, spraying the additional material, applying the additional material on top of the first mesh structure, and/or attaching a tailored patch to the first mesh structure, the tailored patch representing the additional material.

In this eighth embodiment, the gravity-based application of the additional material comprises guiding a flexible material over the first mesh structure to provide the second mesh structure.

In this eighth embodiment, the method may further comprise:
transmitting the generated set of robot instructions to at least one robot, the at least one robot using the transmitted set of robot instructions to provide the second mesh structure.

In this eighth embodiment, if the generated set of robot instructions is transmitted to at least two robots (also called robotic end-effectors), the at least two robots work in parallel to provide the second mesh structure.

In this eighth embodiment, the generated set of robot instructions comprises a time constant, the time constant indicating a time when the at least one robot starts processing the transmitted set of robot instructions to provide the second mesh structure.

In a ninth embodiment, a processing unit is provided for generating a mesh structure, the processing unit configured to use a provided first mesh structure and to perform the steps of:
processing a mesh geometry of the first mesh structure based on an input parameter set to define an operational environment; and
generating a set of robot instructions to apply additional material to the first mesh structure based on the defined operational environment, the additional material being used for modifying the first mesh structure in order to provide a second mesh structure.

In a tenth embodiment, a robot for generating a mesh structure is provided, comprising the processing unit according to the ninth embodiment.

In an eleventh embodiment, a computer program is provided, comprising instructions which, when the program is executed by a computer, causes the computer to carry out the method according to any one of embodiments 8.

In a twelfth embodiment, a mesh structure is disclosed, obtainable by the method according to embodiment 8.

A thirteenth aspect or embodiment (according to application number EP 20 205 632.1) relates to a method for generating mesh data to construct a mesh structure to be used in a constructional building process, comprising:
processing an input geometry object and creating a digital representation of the input geometry object;
structurally evaluating the digital representation of the input geometry object;
determining a structural requirement set; and
generating mesh data based on the digital representation of the input geometry object and the structural requirement set, the mesh data defining a characteristic of a mesh structure to be constructed by a robotic fabrication process.

In the thirteenth embodiment, the structural requirement set is determined based on the structural evaluation of the digital representation.

In the thirteenth embodiment, the method may further comprise segmenting the digital representation of the input geometry object in a plurality of elements, wherein the mesh data is generated based on the plurality of elements and the structural requirement set.

In the thirteenth embodiment, the digital representation is segmented in the plurality of elements based on a size of the mesh structure to be constructed by the robotic fabrication.

In the thirteenth embodiment, the method may further comprise generating a set of construction instructions based on the characteristic of the mesh structure defined in the mesh data, the set of construction instructions being used by a robotic system for the robotic fabrication process of the mesh structure.

In the thirteenth embodiment, the characteristic of the mesh structure comprises a number of nodes in the mesh structure, positions of the nodes in the mesh structure, wire data, topology information of the mesh structure, a type of material used for the mesh structure, a type of joining method, and/or a set of joining parameters.

In the thirteenth embodiment, the input geometry object is modelled in a data structure to create the digital representation of the input geometry object.

In the thirteenth embodiment, the input geometry object is a mesh object and/or a non-uniform rational B-spline (Nurbs) surface.

In the thirteenth embodiment, structurally evaluating the digital representation is based on a structural analysis and/or structural load.

In the thirteenth embodiment, determining the structural requirement set comprises determining a reinforcement requirement set for the mesh structure to be constructed by the robotic fabrication.

In the thirteenth embodiment, the reinforcement requirement set comprises an amount of reinforcement, a type of reinforcement, a type of material used for reinforcement, a reinforcement bar (rebar) spacing, and/or a rebar diameter.

In the thirteenth embodiment, the amount of reinforcement to be placed on a specific position for the mesh structure to be constructed by the robotic fabrication process is calculated based on the input geometry object and a load case.

In the thirteenth embodiment, the method may further comprise checking the generated mesh data for fabrication feasibility and providing a checking result.

In the thirteenth embodiment, checking the generated mesh data for fabrication feasibility comprises checking minimum and maximum spacing, minimum curvature, overlaps, and/or build volume.

In the thirteenth embodiment, if it is determined that fabrication feasibility is not given, the mesh data is adapted by repeating the steps of structurally evaluating the digital representation, determining the structural requirement set, and generating the mesh data, and/or the mesh data is adapted based on the checking result.

In a fourteenth embodiment, a processing unit for generating mesh data to construct a mesh structure to be used in a constructional building process, configured to perform the steps of:

processing an input geometry object and creating a digital representation of the input geometry object;
structurally evaluating the digital representation of the input geometry object;
determining a structural requirement set; and
generating mesh data based on the digital representation of the input geometry object and the structural requirement set, the mesh data defining a characteristic of a mesh structure to be constructed by a robotic fabrication process.

In a fifteenth embodiment, an apparatus is provided for generating mesh data to construct a mesh structure to be used in a constructional building process, the apparatus comprising the processing unit according to the fourteenth embodiment.

In a sixteenth embodiment, computer program comprising instructions which, when the program is executed by a computer, causes the computer to carry out the method according to any one of embodiments thirteen, mentioned above.

Generally, the term “strand” may be construed as “secondary mesh structure” or as rebar, wire or band material or material to be used in mesh construction.

The term “primary building structure” may be construed as primary mesh structure.

The term “feed wire” may be construed as secondary mesh structure.

The properties, features and advantages of this invention described above, as well as the manner they are achieved, become clearer and more understandable in the light of the following description and embodiments, which will be described in more detail in the context of the drawings. This following description does not limit the invention on the contained embodiments. Same components or parts can be labeled with the same reference signs in different figures. In general, the figures are not for scale.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE FIGURES

FIG. 1 shows a schematic representation of an end-effector for connecting of secondary mesh structure 2 ms to a primary mesh structure 1 ms;

FIG. 2a-FIG. 2e shows a process for welding the secondary mesh structure to the primary mesh structure in different phases;

FIG. 3 shows the end-effector with its components in more detail;

FIG. 4 is an overview figure of the process for generating a mesh structure according to a preferred embodiment of the present invention;

FIG. 5 is a block diagram of digital components and related data or message exchange according to another preferred embodiment;

FIG. 6 shows by way of example two end-effectors for mesh generation;

FIG. 7 is an overview figure, representing different coils for providing the secondary mesh structure to be used by the robot for generating the mesh structure;

FIG. 8 is another perspective of the robotic setting with two end-effectors and is platforms with two linear actuators;

FIG. 9 is a block diagram of an end-effector tool with two end-effectors and their respective components according to a preferred embodiment of the invention;

FIG. 10 is a flow chart to a computer-implemented method for instructing steps to be executed on an end-effector;

FIG. 11 is another schematic representation of a robotic process for generating the mesh structure;

FIG. 12 is a flow chart, representing functional dependencies;

FIG. 13 shows the end-effector EE when applying the secondary mesh structure onto the primary mesh structure by rolling over.

### DETAILED DESCRIPTIONS OF THE FIGURES AND PREFERRED EMBODIMENTS

This following description does not limit the invention on the contained embodiments. Same components or parts can be labeled with the same reference signs in different figures. In general, the figures are not for scale.

It shall be understood that a preferred embodiment of the present invention can also be any combination of the dependent claims or above embodiments with the respective independent claim.

These and other aspects of the invention will be apparent from and elucidated with reference to the embodiments described hereinafter.

In case, complex wall or ceiling systems needed to be manufactured, usually it is necessary to provide the concrete with a reinforcement structure. Typically, the reinforcement structure is provided first, like the mesh structure, which may be later filled with concrete. The present invention now relates to the automatic generation of such a mesh structure, in particular a three-dimensional mesh structure for use in constructional engineering, like for example for building reinforced concrete structures. However, the method for generating a mesh structure and us so generated mesh structure may also be applied in other settings, like for example in furniture construction, in façade construction or the like. Further, it is possible to use the generated mesh structure without later filling with concrete.

Depending on the complexity of the respective structure to be built, there exist a variety of different static requirements for the generation of the mesh structure. Typically, a three-dimensional model is provided, which represents the static requirements. For example, the model may require to use different types of wires (for instance different dimensions and/or different material) in different regions of the mesh structure to be built. For example, a region with a lot of curvatures needs a denser reinforcement and thus a mesh structure being denser or comprising mesh elements with a higher diameter. So, the specifications for different regions in one and the same mesh structure may vary.

As mentioned above, the process for finally manufacturing the building structure, comprising the reinforcing mesh structure requires several steps and is time-consuming. Therefore, the present invention aims at a further automation of the mesh generation process.

For this purpose, a robotic end-effector tool has been developed. The robotic end-effector tool (in the following simply abbreviated as tool) may comprise at least one and preferably two end-effectors EE. These end-effectors EE are implemented on and/or supported by an articulated arm, so that the end-effector EE is able to move in 6 degrees of freedom. Thus, preferably, the end-effector and/or the end-effector tool is mobile.

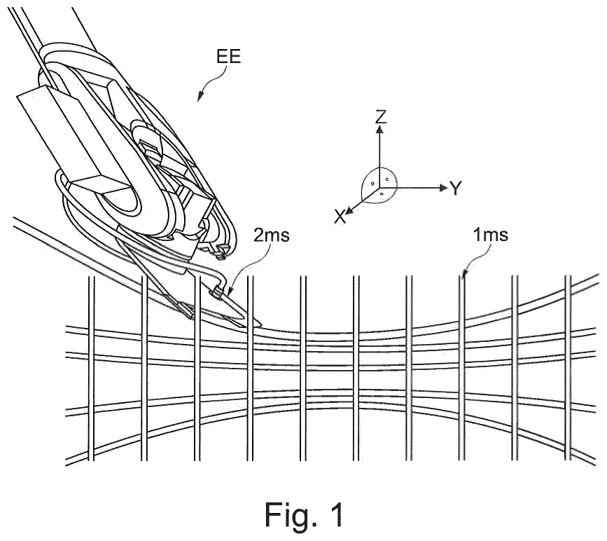

Such an end-effector EE is shown in FIG. 1. As can be seen, the end-effector EE comprises a head, which is depicted schematically in FIG. 1. The end-effector EE is configured to connect a secondary mesh structure 2 ms, which preferably may be provided as wire, to a primary mesh structure 1 ms. The primary mesh structure 1 ms may be pre-fabricated and is typically provided as two- or three-dimensional mesh wire structure, as can be seen in FIG. 1.

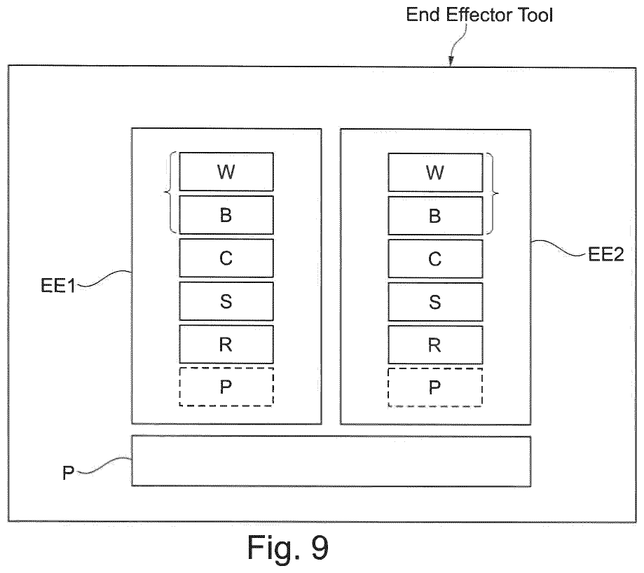

The end-effector EE may comprise different modules for via processing, in particular:
A welding unit W, which is configured for welding wire. The welding unit W may be used for welding-off wire from the mesh structure, typically from the primary mesh structure 1 ms. The welding unit W may also be configured to be used to weld the secondary mesh structure 2 ms onto the primary mesh structure 1 ms. In a preferred embodiment, the welding unit W is the resistance or contact welding unit.
A bending unit B, which is configured for bending wire. The bending unit B is typically used for bending the secondary mesh structure 2 ms according to the shape of the primary mesh structure 1 ms. In a preferred embodiment the bending unit B may be provided as anode of the welding unit W. So, one part of the welding unit W additionally serves as bending unit B as well. This is reflected in FIG. 9 with the bracket around the welding unit W and the bending unit B.
A set of sensors S, comprising at least one sensor for detecting a contact force which is applied by end-effector EE onto the primary mesh structure 1 ms. Preferably, one contact force sensor is provided at the head of the end-effector EE. Optionally, further sensors may be provided, including terminal sensors, noise sensors, optical sensors and/or other sensors for detecting signals during rolling over the primary mesh structure 1 ms.
The rebar threader R for providing the secondary mesh structure 2 ms (for instance in the form of a rebar strand) from our supply unit, like a coil. The rebar threader R is a hollow structure with an inlet and an outlet for guiding the secondary mesh structure 2 ms (or rebar) from the supply of oil to the rolling anode.
Optionally, the end-effector EE may comprise a cutter C, which is configured for cutting wire, and in particular for cutting the secondary mesh structure 2 ms after completion of the sequence of welding processes.

In a preferred embodiment, the anode of the welding unit is configured as bending unit, so that no separate component is necessary for bending. In this case the bending unit B is implemented or integrated in the welding unit W.

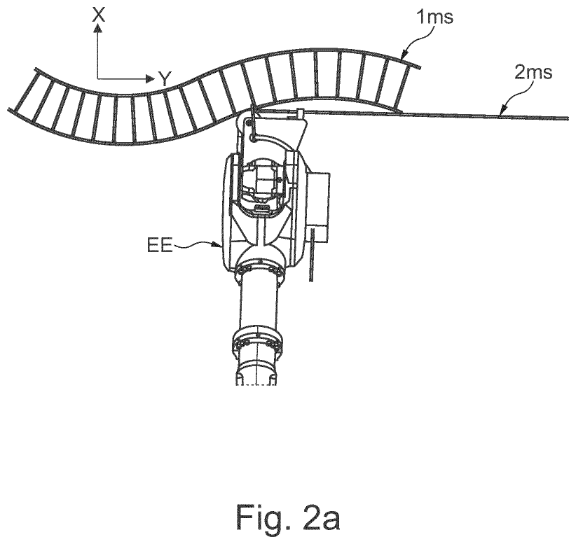

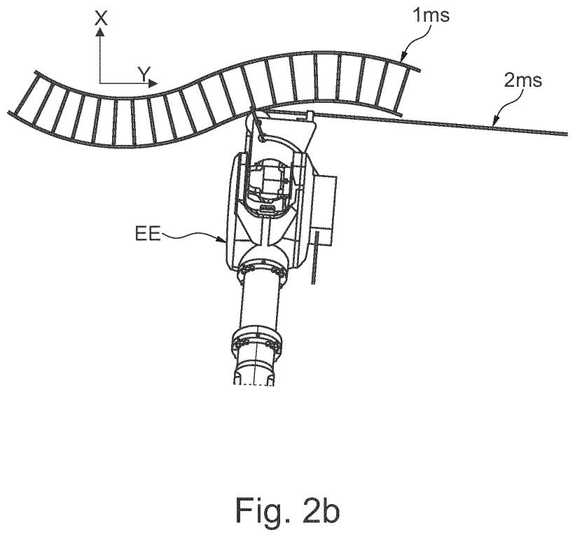

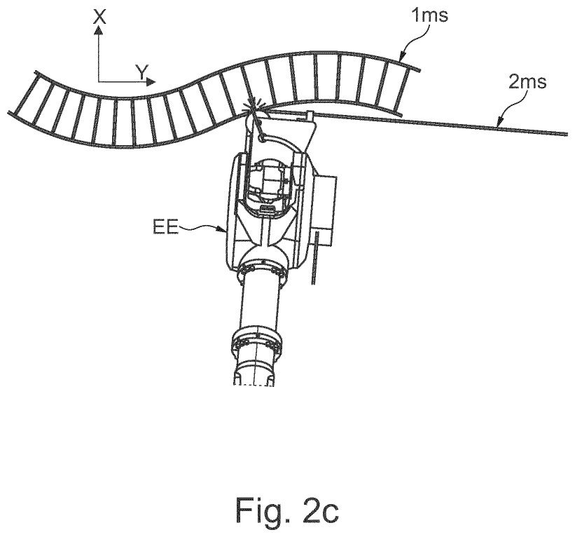

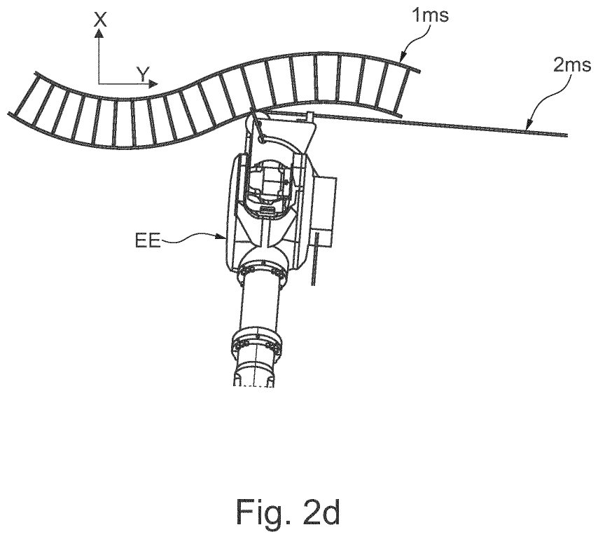

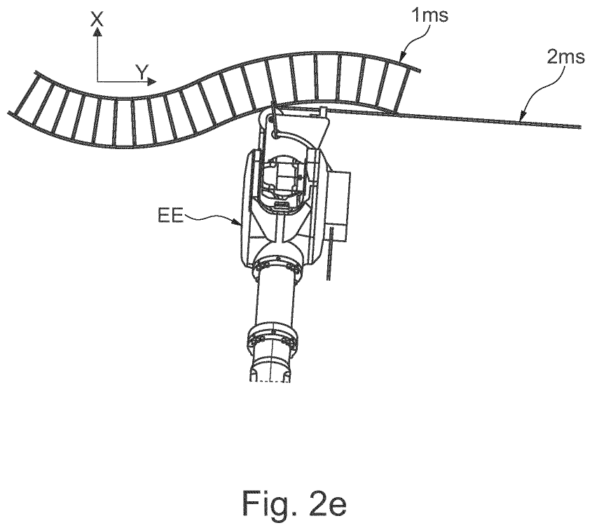

FIG. 9 schematically shows the end-effector tool with two end-effectors EE1, EE2, each comprising the welding unit W, the bending unit B, a cutter C and the set of sensors S with the contact force sensors. Preferably, the welding unit W is a resistance welding unit and comprises an anode which is preferably implemented as rotating roll, as can be seen in FIG. 2a-d and/or might be made from copper. The anode in the form of the rotating roll is configured to be rolled over the primary mesh structure 1 ms with the secondary mesh structure 2 ms. The welding unit W further comprises a cathode which preferably is implemented as dog or carrier.

The carrier may be provided as rectangular unit and may be attached on a support member at the end-effector EE, so that the cathode may swivel or pivot around an axis, extending perpendicular to the surface of the primary mesh structure 1 ms. Generally, it is key that the cathode touches the respective primary structure that is welded to the secondary structure before sending the weld signal. As can be seen in FIG. 2, the cathode is supported at the end-effector EE to engage with the primary mesh structure 1 ms when the end-effector EE is rolled over the primary mesh structure 1 ms. The cathode is forced to swivel around the above-mentioned axis when the end-effector EE is moved translatory in a Y- and/or Z axis. If the end-effector EE is moved from one wire element (element of the primary mesh structure 1 ms, over which the end-effector EE with the secondary mesh structure 2 ms is rolled) to the next wire element of the primary mesh structure 1 ms, the cathode is forced to hop or jump to the next element. Preferably, the cathode is spring-mounted on a support member of the end-effector EE.

As represented in FIG. 9 with dotted lines, the processor P may be implemented on the end-effector tool or may be associated thereto. Alternatively, or in addition, the processor P may also be implemented on each or on selected end-effectors locally. Both, of the above-mentioned alternatives may be combined.

Further, the end-effector EE may comprise a rebar threader R for forwarding the rebar or wire of the secondary mesh structure 2 ms to the end-effector EE from a coil.

FIGS. 2a to 2e shows a top view of the end-effector EE during rolling over the primary mesh structure 1 ms for welding the secondary mesh structure 2 ms at pre-configured positions. Typically, the welding positions are defined by the three-dimensional model. A welding position is defined by a wire crossing between a wire of the primary mesh structure 1 ms and the wire of the secondary mesh structure 2 ms. Depending on the model, not every wire of the primary mesh structure 1 ms needs to be subject for the welding process. With other words it is possible that only a selection of wire elements of the primary mesh structure 1 ms are subject to the welding process. In FIG. 2a-e the following different states in the course of rolling-over can be seen:

a) End-effector EE approaching welding position;
b) Cathode touching primary structure 1 ms;
c) Welding by means of the welding unit W;
d) Welding finished;
e) Cathode jumping from one primary structure element to the next while the robot is moving along the desired trajectory.

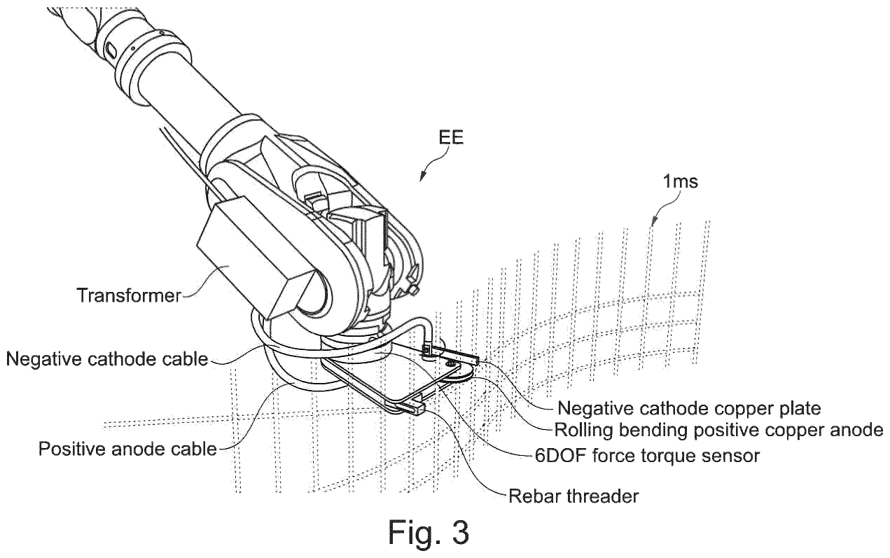

FIG. 3 shows the head of the end-effector EE in another perspective. The end-effector EE is provided with a transformer, the cuboid component in FIG. 3, for providing the appropriate voltage. The cathode and the anode are electrically connected for voltage supply by a cathode cable and an anode cable. As already described above, the cathode is preferably provided as rectangular bar, which is spring-mounted and rotatable around an axis being perpendicular to the movement direction of the end-effector EE and/or usually parallel to the (e.g., vertically extending) elements of the primary mesh structure 1 ms. In this respect it has to be noted, that the rotation axis for the spring-mounted cathode has a lateral offset to the surface of the primary mesh structure 1 ms.

In a preferred embodiment and as shown in FIG. 3, the anode is provided as rolling bending unit B. Thus, the anode has two functions:
1. for welding, besides the cathode, as part of the welding unit W and
2. for bending; the anode serves as a bending unit B for bending the secondary mesh structure 2 ms in the direction, being parallel to the surface of the primary mesh structure 1 ms along with the movement of the end-effector EE rolling over the primary mesh structure. As can be seen in FIG. 3, the anode may be provided as pulley or roll, being rotatable around a rotation axis, being perpendicular the movement direction the effector EE and/or parallel to the surface of the primary mesh structure 1 ms.

The end-effector EE itself is movable in 6DOF of freedom. Further, the end-effector EE comprises the rebar threader R for providing the secondary mesh structure 2 ms in the form of wire or rebar as mentioned above (see FIG. 9).

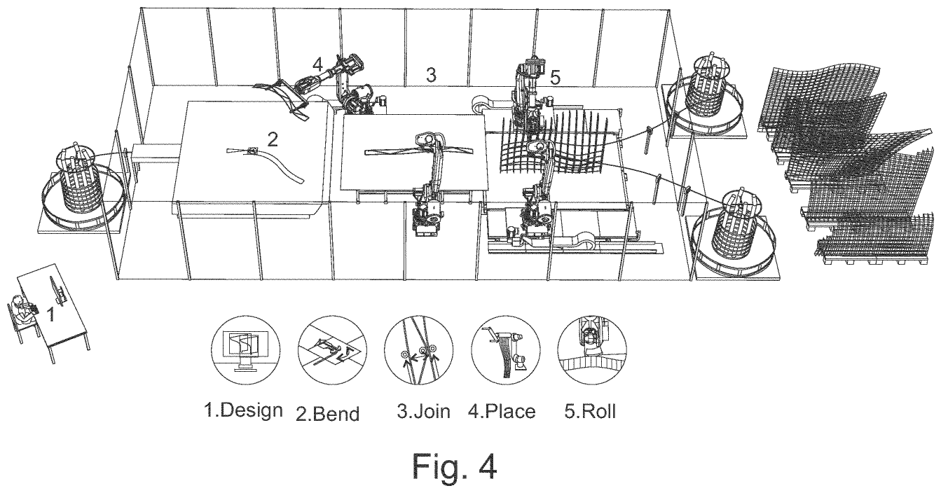

FIG. 4 shows the whole process for generating the mesh structure in a schematic overview figure. In step 1 a 3D mesh model is generated to be provided in a digital form to several computing entities and processors. A two-dimensional part of the primary mesh structure 1 ms is fabricated in step 2 by means of using robots (step 4) which are configured for bending the appropriate wire into a form which is defined by the 3D mesh model. A set of such two-dimensional parts of the primary mesh structure 1 ms are placed (and non-permanently attached, for instance by welding connections) on a platform (step 5) in order to generate the primary mesh structure 1 ms, which is a three-dimensional mesh structure. This primary mesh structure 1 ms e.g., with curvatures in different axes serves as basis for generating the mesh structure with a method according to the present invention. The primary mesh structure 1 ms is processed by the mobile robotic end-effector tool with an end-effector EE for welding two different types of rebar/wires or secondary mesh structures 2 ms, stocked on two different coils, as can be seen in FIG. 4 on the right-hand side onto the primary mesh structure 1 ms. The robotic end-effector EE is provided on an articulated robotic arm, which itself is articulated attached on a platform. The platform may be moved by linear driver motors. Thus, the platform with the end-effector EE may be moved in lateral direction and mainly in parallel to the surface of the primary mesh structure 1 ms. The end-effector EE is instructed to roll over the primary mesh structure 1 ms in order to weld the secondary mesh structure 2 ms at configurable welding positions. Typically, the rolling over process is reiterated in different heights (Z axis direction), depending on the static requirements. Usually, the secondary mesh structure 2 ms may be welded in a configurable angle onto elements of the primary mesh structure 1 ms. For some applications, a 90° angle between the secondary mesh structure 2 ms and the primary mesh structure 1 ms is favorable. After having completed all roll spot weldings with a plurality of different sequences (preferably a plurality of rows or lines of the secondary mesh structure), the final mesh is generated, as can be seen in FIG. 4 on the right-hand side.

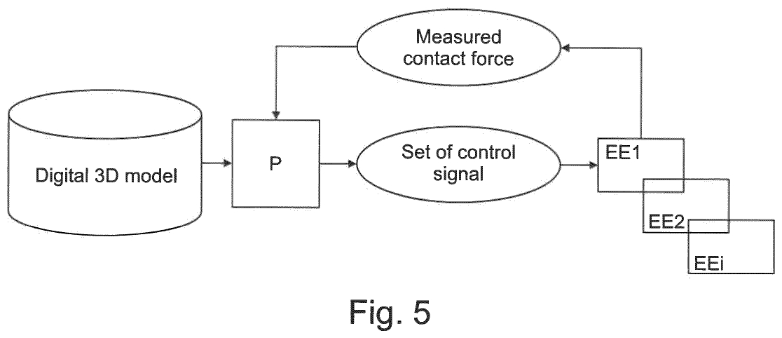

FIG. 5 shows the general data exchange. A processor P (also referred to herein as processing unit) serves to calculate control instructions for control of the robotic end-effector tool with the at least one end-effector EE. Further, the processor P serves to receive the digital three-dimensional model, representing requirements for the mesh structure to be built. The requirements, inter alia, are defining the type of secondary mesh structure 2 ms (for instance rebar strands from metal or in another material, in a certain diameter, and/or with certain physical—chemical properties etc.). The processor may be configured to generate:
1. static control instructions, which are fix and static for one process of rolling over (the secondary mesh structure onto the primary mesh structure). The static control instructions may in a preferred embodiment be solely calculated on the basis of the 3D model and may e.g., take into account material properties for defining welding parameters like the welding current, voltage etc.
2. Dynamic control instructions, which are variable or may change over the process of rolling over. The dynamic control instructions are preferably calculated in response to the measured contact force and/or the target contact force. The target contact force may be determined by the 3D model. The dynamic control instructions may preferably relate to the positioning instructions for the end-effector EE (target trajectory).

Based on the information in the model, the processor P calculates control instructions with a set of control signals for instructing the set of end-effectors EE1, EE2, EE3. The control signals comprise trajectory signals, defining the desired trajectory, the end-effector EE is required to move along the primary mesh structure 1 ms. Usually, the trajectory signals are predefined by the digital three-dimensional model only approximately or roughly, because the primary mesh structure is compliant and may go to side or move back/side or away, if a force is applied to it in direction of the normal onto the surface of the primary mesh structure. Such a force is applied inevitably when the end-effector is rolled over the primary mesh structure, which prompts the primary mesh structure—at least at that position—to change its position in X direction (bounce back a little). Therefore (because of the moving target namely the primary mesh structure) the trajectory needs to be adapted according to the instantaneous and dynamically measured contact force at that point. Further, the force is physically dependent of the position of the end-effector EE. For example, if the end-effector EE is moved along a desired trajectory over the primary mesh structure and a target force Ft needs to be applied at a particular position, due to the flexibility of the primary mesh structure (bounce backwards) the actually measured force Fa (measured at that position) might be lower than the target force Ft. Then, the end-effector EE may be controlled to reposition (offset in X direction towards the primary mesh structure) so that the target force Ft may be reached. If the actually measured force Fa is too high, the control signals may instruct the end-effector EE to reposition (away from the primary mesh structure) so that the target force Ft may be reached.

The set of control signals further comprises signals, defining the welding process and may be referred to as welding control signals. The welding control signals serve and are adapted to define the welding process of the welding unit W of the respective end-effector EE. The welding control signals may comprise: the welding current, the welding voltage, the welding power, the welding energy. Typically, the above-mentioned control signals are kept constant, whereas the contact force is controlled dynamically. A control of the electrical variables and, in particular, a control of the contact force is important for ensuring stability of the mesh and its welding connections. The welding control signals are preferably optimized in view of material properties and parameters (e.g., mesh diameter etc.). The static welding control signals (e.g., except the contact force) may be pre-set and may preferably be kept constant during rolling over the primary mesh structure 1 ms (by the end-effector EE).

The contact force is processed in two different instances: as measured contact force and as instructed contact force. On the one hand, the contact force is measured by sensors at the end-effector EE continuously. On the other hand, the contact force is instructed by a processor P to be applied when performing the welding spots. The measured contact force may differ from the instructed contact force for a number of reasons. Mainly material deformation and/or material twisting and/or distortions and/or other forms of re-positionings of the primary mesh structure may be the reason for the deviations. With this, a closed control loop for controlling the welding parameters for the welding process may be provided.

One major advantage of the present invention is, that the contact force is dynamically and/or adaptively controlled in a closed loop control. For this purpose, the end-effector EE comprises sensors for measuring the contact force. Generally, the contact force may be influenced by a variety of different parameters, including static parameters, like geometric parameters of the primary mesh structure 1 ms, and dynamic parameters, like e.g., additional forces being applied to the primary mesh structure 1 ms at that timepoint (for instance from another end-effector EE, working in parallel on the primary mesh structure 1 ms and/or other technical parameters). Thus, the measured and instructed contact force may vary from position to position over the primary mesh structure or may vary over time. Further, the correct application of the contact force is essential for the quality of the welding process and needs to be controlled. If, on the one hand, the contact force is applied too low, a sufficient welding connection between the respective wires cannot be assured and quality may be impaired. If, on the other hand, too much contact force is applied, the welding process takes too long and the structure of the respective wires may be impaired. Therefore, a correct and appropriate application of the contact force is essential. Further, the contact force to be applied is dependent on the physical parameters of the respective two rebars (wires of the first and secondary mesh structure) to be connected, like for example the diameter of the rebars. The goal of the control loop is to keep the contact force constant per element, by adjusting the position of the end-effector. A different target force might be defined if the material and/or diameter changes.

The process of contact welding (resistance welding) may preferably be controlled such as to provide a constant and continuous contact force and/or also other welding parameters over time and in particular during rolling over the primary mesh structure. In contrast to usual process control in resistance spot welding, which has the task of controlling/guiding the welding process in the case of changing influencing variables in such a way that sufficient joint quality of the resulting weld spot is ensured the present suggestion, presented herein serves to adapt the trajectory and/or position over time/movement of the end-effector for indirectly influencing and controlling at least one welding parameter, namely the contact force.

According to a preferred embodiment of the invention, the contact force, in particular the instructed contact force, is controlled adaptively and in response to the measured contact force during the process of rolling over the primary mesh structure 1 ms. For example, a first secondary mesh structure needs to be applied with a different contact force than a second secondary mesh structure. having e.g., another welding resistance and/or for which another welding voltage and/or current have been measured.

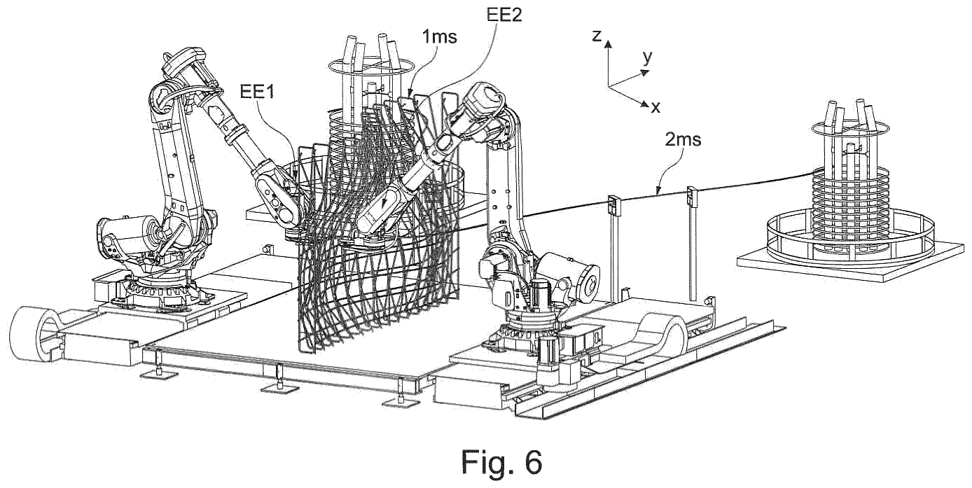

FIG. 6 shows an end-effector tool, comprising two separate end-effectors EE, working from opposite sides on the same primary mesh structure 1 ms. In a preferred embodiment, the two end-effectors EE are controlled in common so that they are positioned at corresponding positions on opposite sides of the primary mesh structure 1 ms and thus have a corresponding position in the Y- and Z-axis for force balancing. As can be seen the secondary mesh structures 2 ms are provided on two different coils. Each end-effector EE is positioned on a separate platform. Each platform is movable by drive motors. Preferably the platform is movable in one axis (laterally), namely in the Y-axis. In addition, the end-effector EE is provided at an articulated arm and is thus mobile in 6 DOF of freedom to operate on the primary mesh structure 1 ms.

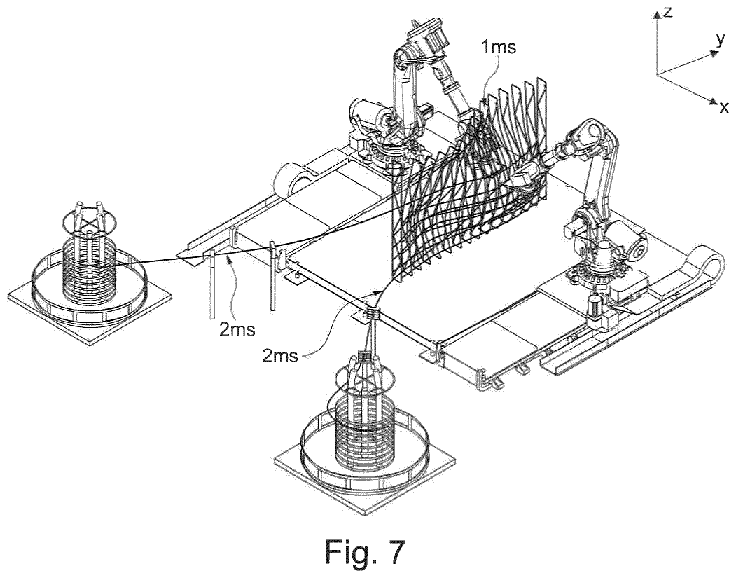

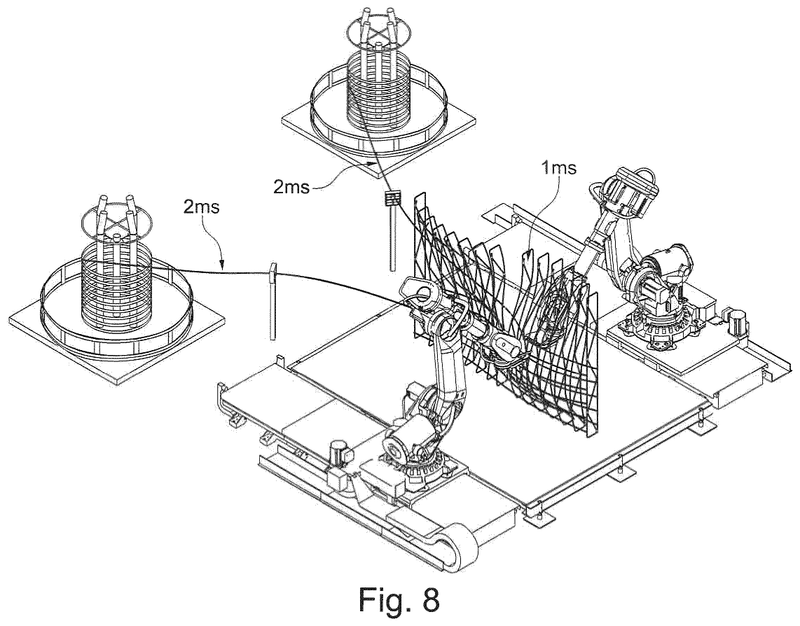

FIGS. 7 and 8 show a similar setting as FIG. 6 in another perspective with the two coils for providing the secondary mesh structure 2 ms being provided below or besides the platforms.

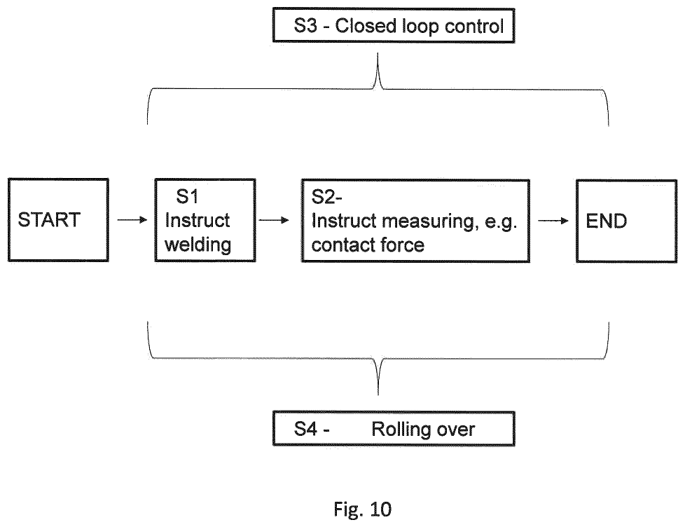

FIG. 10 shows in an abstract representation of the process of rolling over the primary mesh structure 1 ms for roll spot welding. The start of the actions of the end-effector EE may be initiated upon an initiation signal, which may be provided on a user interface, e.g., associated to a server computer or to the processor P. The process may be executed in a processor P, which may be implemented on different computing entities. The processor P is configured for control of the end-effector EE. The processor may be implemented on the end-effector EE or a related computing entity, being in data exchange. In step S1 the welding may be instructed by respective control signals. In step S2 the measurement may be instructed by respective control signals. Alternatively, the measurement is executed continuously and the measured signals are processed upon instruction (by the processor P). The steps are to be understood as action to be performed during rolling over—represented in FIG. 10 by reference numeral S4 —; they may be executed in parallel or in another sequence or interleaved. During the process of rolling over, roll spot welding is performed. In parallel, the end-effector EE and in particular the welding process of the welding unit W of the end-effector EE is controlled dynamically, shown with S3. The action roll-over S4 and control S3 are executed in parallel.

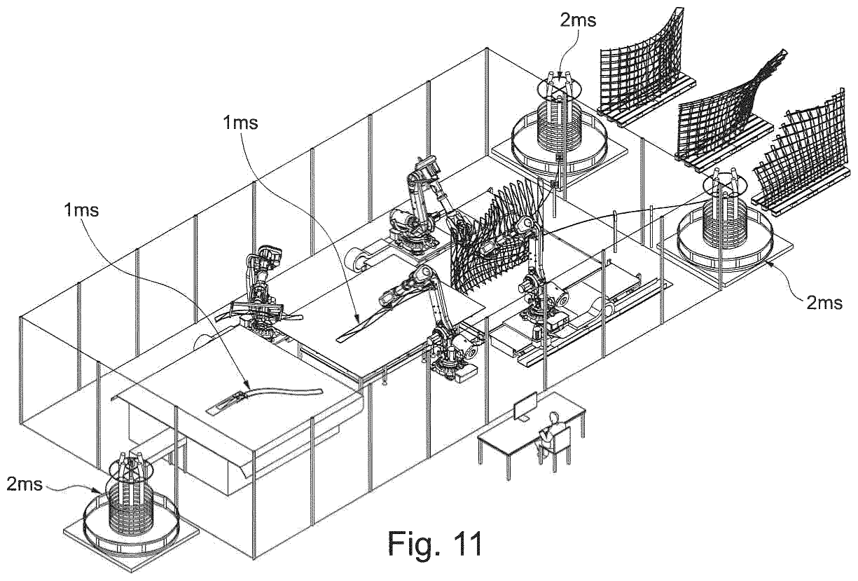

FIG. 11 shows a manufacturing pipeline or robotic process for generating the mesh structure from left to right. The secondary mesh structure 2 ms (wire), represented on the left downward section in FIG. 11 may be used for generating the first mesh structure 1 ms (2D part) by bending robots in a preceding step. The so generated first mesh structure 1 ms (2D part) may be fabricated in sequence, one after the other. In a next process step of the automation pipeline shown in FIG. 11, a set of such 2D-parts are the fixed on a platform and are referred to herein as first mesh structure 1 ms. These separate first mesh structures 1 ms need to be connected to each other to generate the (final mesh structure) by another secondary mesh structure (here: two different wires), shown on the right of FIG. 11. Typically, another instance or element of the secondary mesh structure is used for generating the first mesh structure (as shown on the left) as the secondary mesh structure which is used to connect the set of first mesh structures (to provide the final mesh structure), shown in this figure on the right.

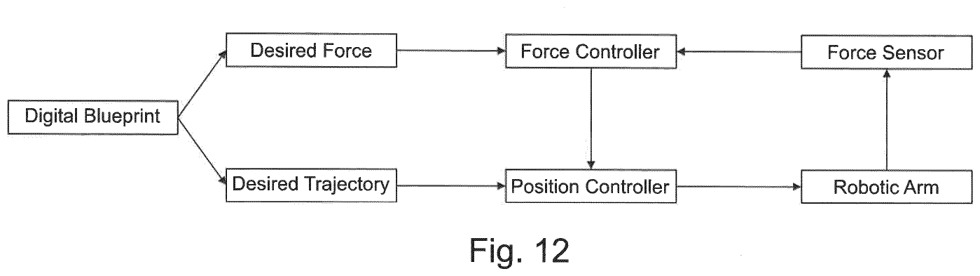

FIG. 12 shows functional dependencies of involved parameters according to a preferred embodiment of the present invention. A digital blueprint may be stored in a storage and indicates the target or desired force as well es the target or desired trajectory for movement of the end-effector EE, to be applied when welding the secondary mesh structure 2 ms to the primary mesh structure 1 ms. Preferably, two separate controllers are used: one controller for controlling the contact force of the end-effector EE and one controller for controlling the position/movement of the same. At the robotic arm of the end-effector EE, in particular at the head of the same, a contact force sensor is attached, which is configured for continuously measuring the contact force or pressure, which is provided to the processor P (not shown) to compare the measured contact force with the desired contact force and to calculate in response to this comparison an adapted trajectory for the position controller.

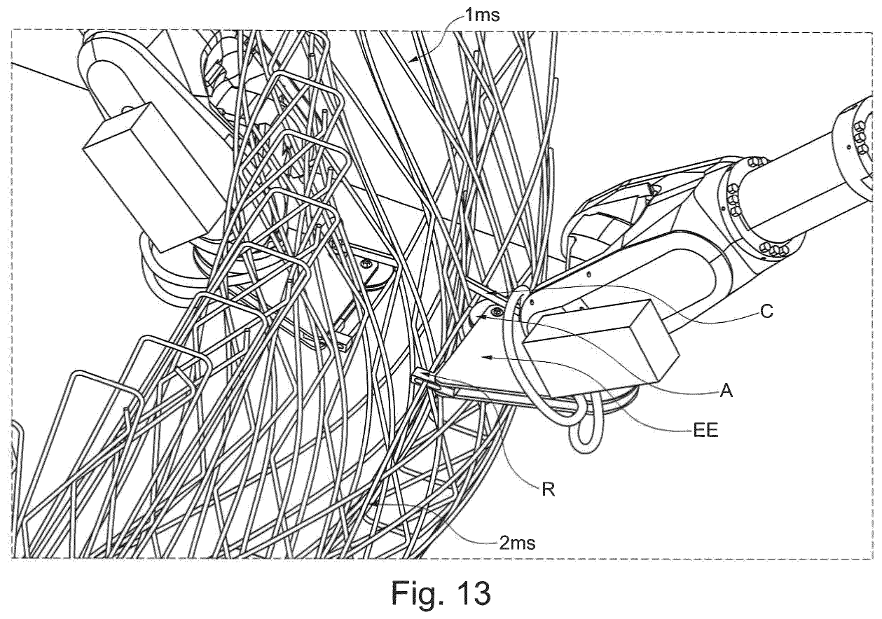

FIG. 13 shows the end-effector EE while rolling over the primary mesh structure 1 ms. Here, the rectangular cathode is referenced with numeral C and the rolling anode with numeral A and the rebar threader with numeral R which provides the secondary mesh structure 2 ms to the robotic end-effector EE. The cathode C engages with the primary mesh structure 1 ms as it hops from wire element to wire element of the primary mesh structure 1 ms while the end-effector EE with its anode A is rolling over the primary mesh structure 1 ms. As indicated in FIG. 13, two of such end-effectors EE may be used from opposite sides, working in parallel on the primary mesh structure 1 ms.

Wherever not already described explicitly, individual embodiments, or their individual aspects and features, described in relation to the drawings can be combined or exchanged with one another without limiting or widening the scope of the described invention, whenever such a combination or exchange is meaningful and in the sense of this invention. Advantages which are described with respect to a particular embodiment of present invention or with respect to a particular figure are, wherever applicable, also advantages of other embodiments of the present invention.

1. Method for generating a mesh structure for use in constructional engineering, in particular for use in reinforcement systems, comprising the method steps of:
Providing a primary mesh structure (1 ms),
Using a robotic end-effector tool with at least one end-effector (EE), being movable in six degrees of freedom for applying an endless secondary mesh structure (2 ms) to the provided primary mesh structure (1 ms) continuously by roll spot welding;
and during rolling over (S4) the primary mesh structure (1 ms) for roll spot welding:
instructing (S1) a welding unit (W), in particular a resistance welding unit, to initiate a welding process in a sequence of interrupted welding processes for welding the secondary mesh structure (2 ms) to the primary mesh structure (1 ms) at pre-defined connection positions to generate cross weldings;
instructing (S2) a set of sensors (S) to measure a contact force at the robotic end-effector (EE), being applied to the primary mesh structure (1 ms) during rolling over (S4) the primary mesh structure (1 ms);
controlling (S3) the robotic end-effector in real-time with control signals, generated by a processor (P), wherein the control signals are generated at least in part in response to the measured contact force.

2. Method according to claim 1, wherein the welding unit (W) is a resistance welding unit or a gas metal arc welding unit or a tying gun for providing a tying connection.

3. Method according to any of the preceding claims, wherein the control signals comprise first control signals, being dynamic and indicating a trajectory for movement of the end-effector (EE) and second control signals, indicating welding parameters for executing the welding process in the sequence of interrupted welding processes and/or wherein the second control signals are static.

4. Method according to the directly preceding claim, wherein the first control signals are determined on the basis of the measured contact force and/or wherein the second control signals are determined on the basis of a 3D mesh model.

5. Method according to any of the preceding claims, wherein the secondary mesh structure (2 ms) is or comprises a strand of continuous mesh material, in particular mesh wire.

6. Method according to any of the preceding claims, wherein the secondary mesh structure (2 ms) is bent by means of the end-effector and in particular by means of an anode of the welding unit (W) and/or wherein the secondary mesh structure (2 ms) is bent during rolling over the primary mesh structure (1 ms), in particular according to a curvature of the first mesh structure (1 ms).

7. Method according to any of the preceding claims, wherein the secondary mesh structure (2 ms) is not cut to length while rolling over the primary mesh structure (1 ms) and/or wherein the secondary mesh structure (2 ms) is not cut to length before an outer side of the primary mesh structure (1 ms) has been reached after the process of rolling over the primary mesh structure (1 ms) has started.

8. Method according to any of the preceding claims, wherein the sequence of interrupted welding processes is applied with one and the same endless secondary mesh structure (2 ms).

9. Method according to any of the preceding claims, wherein the robotic end-effector tool comprises at least two separate end-effectors (EE) at two different robotic arms, wherein the two separate end-effectors are used in parallel for applying different items of the secondary mesh structure (2 ms) to the primary mesh structure (1 ms), in particular on the same height and/or in the same longitudinal extension in the Y-axis from opposite sides.

10. Method according to any of the preceding claims, wherein the contact force is measured by means of a force measurement sensor, which is attached at a head of the robotic end-effector (EE), in particular in an area where the contact force is applied.

11. Method according to any of the preceding claims, wherein during the sequence of interrupted welding processes, the secondary mesh structure (2 ms) remains in endless form and is not cut.

12. Method according to any of the preceding claims, wherein the secondary mesh structure (2 ms) is welded to the primary mesh structure (1 ms) horizontally or vertically or in an angle between 0° and 90° with respect to a direction of an element of the primary mesh structure (1 ms).

13. Method according to any of the preceding claims, wherein the at least one end-effector (EE) is adapted:
to weld the secondary mesh structure (2 ms) onto the primary mesh structure (1 ms);
to weld elements off the primary mesh structure (1 ms);
to move and in particular to roll over the primary mesh structure (1 ms), by translatory and/or rotational movements, depending on the curvature of the primary mesh structure (1 ms);
to bend the secondary mesh structure (2 ms), in particular in case the primary mesh structure (1 ms) is not planar, and/or
to cut the secondary mesh structure (2 ms) after completion of the sequence of interrupted welding processes.

14. Method according to any of the preceding claims, wherein the at least one end-effector (EE) comprises an anode and a cathode, wherein the anode is provided as rotating roller and the cathode is provided as rotating carrier, which hops or skips to a respective next element of the primary mesh structure (1 ms).

15. Method according to any of the preceding claims, wherein the at least one robotic end-effector (EE) is placed on a mobile platform, and/or wherein the mobile platform is transferable by a linear actuator for linear movement, in particular parallel to a plane of the primary mesh structure (1 ms).

16. Method according to any of the preceding claims, wherein the at least one robotic end-effector (EE) is moved along a trajectory over the primary mesh structure (1 ms) according to control instructions which are calculated on the basis of a digital 3D-model.

17. A robotic end-effector tool for generating a mesh structure for use in constructional engineering, in particular for use in reinforcement systems, which is configured to be used in a method according to any of the preceding method claims, comprising:
at least one robotic end-effector (EE), being movable in six degrees of freedom for applying an endless secondary mesh structure (2 ms) to the provided primary mesh structure (1 ms) continuously by roll spot welding,
wherein the at least one robotic end-effector (EE) further comprises:
a welding unit (W), in particular a resistance welding unit, configured for welding the secondary mesh structure (2 ms) to the primary mesh structure (1 ms) at pre-defined connection positions to generate cross-wire connections;
contact force sensors, configured for measuring the contact force of the robotic end-effector (EE), being applied to the primary mesh structure (1 ms) during rolling over the primary mesh structure (1 ms);
a processor (P) for closed loop control of the at least one robotic end-effector (EE) by means of control signals, wherein the control signals are generated at least in part in response to the measured contact force.

18. The robotic end-effector tool according to the directly preceding claim, wherein the welding unit (W) comprises an anode and a cathode, and wherein the anode is configured for bending the secondary mesh structure (2 ms) during rolling over the primary mesh structure (1 ms).

19. A computer program comprising a computer program code, the computer program code when executed by a processor causing a robotic end-effector tool according to the directly preceding claim to perform the steps of the method of any of the preceding method claims, when the robotic end-effector (EE) is provided with a primary mesh structure (1 ms) and in case an initiation signal is provided.
